(19) United States
(12) Patent Application Publication
(10) Pub. No.: US 2022/0174530 A1
(43) Pub. Date: Jun. 2, 2022

(54) BASE STATION AND COMMUNICATION METHOD

(71) Applicant: Panasonic Corporation, Osaka (JP)

(72) Inventor: Hiroaki SUDO, Kanagawa (JP)

(21) Appl. No.: 17/441,753

(22) PCT Filed: Mar. 18, 2020
(86) PCT No.: PCT/JP2020/012088

§ 371 Date: Sep. 22, 2021

(30) Foreign Application Priority Data
Mar. 27, 2019 (JP) 2019-061454
Jun. 28, 2019 (JP) 2019-121145

(51) Int. Cl. H04W 24/10; H04W 24/08

(52) U.S. Cl. CPC H04W 24/10; H04W 24/08

(57) ABSTRACT

This base station that supports a first wireless system and belongs to first network comprises: an interference classification unit that classifies first interference from a wireless device supporting the first wireless system and belonging to the first network, and interference including second interference from a wireless device that supports the first wireless system and belongs to a second network differing from the first network; and a control unit that outputs notification information to a first network control device, said notification information including information that relates to the first interference and information that relates to the interference including the second interference.

### TECHNICAL FIELD

The present disclosure relates to a base station and a notification method.

### BACKGROUND ART

Unlicensed bands can be used for communication between radio communication apparatuses (for example, between a base station and a terminal). Unlicensed bands are used by various radio systems, so interference may occur due to a plurality of factors.

### CITATION LIST

### Patent Literature

### PTL 1

Japanese Patent Application Laid-Open No. 2013-081089

### SUMMARY OF INVENTION

### Technical Problem

However, as concerns about a method of appropriately providing notification of an interference detection result in a band used by various radio systems, there is room for study.

Non-limiting embodiments of the present disclosure facilitate providing a base station and a notification method capable of appropriately providing notification of an interference detection result in a band used by various radio systems.

A base station according to one example of the present disclosure is a baes station that supports a first radio system and that belongs to a first network, the base station including: an interference classification processor that classifies interference including first interference from a radio apparatus that supports the first radio system and that belongs to the first network, and second interference from a radio apparatus that supports the first radio system and that belongs to a second network different from the first network; and a controller that outputs notification information including information on the first interference and information on interference including the second interference to a control apparatus of the first network.

A notification method according to one example of the present disclosure includes: classifying interference including first interference from a radio apparatus that supports a first radio system and that belongs to a first network and second interference from a radio apparatus that supports the first radio system and that belongs to a second network different from the first network; and generating notification information including information on the first interference and information on including the second interference.

It should be noted that general or specific embodiments may be implemented as a system, an apparatus, a method, an integrated circuit, a computer program, a storage medium, or any selective combination thereof.

According to one example of the present disclosure, it is possible to appropriately provide notification of an interference detection result in a band used by various radio systems.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram showing the outline of radio systems including LPWA;

FIG. 2 is a view showing an example of the format of notification information for providing notification of an interference detection result;

FIG. 3 is a block diagram showing a configuration example of a base station according to one embodiment of the present disclosure;

FIG. 4 is a view showing a first example of the format of notification information according to one embodiment of the present disclosure;

FIG. 5 is a view showing a second example of the format of notification information according to one embodiment of the present disclosure;

FIG. 6 is a flowchart showing a first example of a notification information generating process according to one embodiment of the present disclosure;

FIG. 7 is a flowchart showing a first example of a process to be executed in S105 of FIG. 6;

FIG. 8 is a flowchart showing a first example of a process to be executed in S209 of FIG. 7;

FIG. 9 is a view showing a first modification of the format of notification information, shown in FIG. 5;

FIG. 10 is a view showing a second modification of the format of notification information, shown in FIG. 5;

FIG. 11 is a view showing a third modification of the format of notification information, shown in FIG. 5;

FIG. 12 is a flowchart showing a second example of a process to be executed in S209 of FIG. 7;

FIG. 13 is a view showing a third example of the format of notification information according to one embodiment of the present disclosure;

FIG. 14 is a view showing a modification of the format of notification information, shown in FIG. 13;

FIG. 15 is a view showing an example of determination as to the priority of ambient noise;

FIG. 16 is a flowchart showing a third example of a process to be executed in S209 of FIG. 7;

FIG. 17 is a view showing a fourth example of the format of notification information according to one embodiment of the present disclosure;

FIG. 18 is a view showing a modification of the format of notification information, shown in FIG. 17;

FIG. 19 is a flowchart showing a second example of a process to be executed in S105 of FIG. 6;

FIG. 20 is a view showing a fifth example of the format of notification information according to one embodiment of the present disclosure;

FIG. 21 is a view showing a sixth example of the format of notification information according to one embodiment of the present disclosure;

FIG. 22 is a view showing a seventh example of the format of notification information according to one embodiment of the present disclosure;

FIG. 23 is a flowchart showing a second example of a notification information generating process according to one embodiment of the present disclosure;

FIG. 24 is a flowchart showing a first example of a process to be executed in S1105 of FIG. 23;

FIG. 25 is a view showing an eighth example of the format of notification information according to one embodiment of the present disclosure;

FIG. 26 is a view showing a ninth example of the format of notification information according to one embodiment of the present disclosure;

FIG. 27 is a flowchart showing a third example of a notification information generating process according to one embodiment of the present disclosure;

FIG. 28 is a flowchart showing a first example of a process to be executed in S1301 of FIG. 27;

FIG. 29 is a view showing a tenth example of the format of notification information according to one embodiment of the present disclosure;

FIG. 30 is a flowchart showing a fourth example of a notification information generating process according to one embodiment of the present disclosure;

FIG. 31 is a flowchart showing a first example of a process to be executed in S1503 of FIG. 30;

FIG. 32 is a view showing an eleventh example of the format of notification information according to one embodiment of the present disclosure;

FIG. 33 is a flowchart showing a second example of a process to be executed in S1503 of FIG. 30;

FIG. 34 is a view showing a first example of the formats of notification information at two different notification timings;

FIG. 35 is a view showing a second example of the formats of notification information at two different notification timings;

FIG. 36A is a view showing an example of the formats of notification information at four different notification timings;

FIG. 36B is a view showing an example of the formats of notification information at four different notification timings; and

FIG. 37 is a flowchart showing a second example of a process to be executed in S1301 of FIG. 27.

### DESCRIPTION OF EMBODIMENTS

Hereinafter, preferred embodiments of the present disclosure will be described in detail with reference to the accompanying drawings. In the specification and drawings, like reference signs are assigned to component elements having substantially the same functions, and the description will not be repeated.

### One Embodiment

In IoT (Internet of Things) and/or M2M (Machine to Machine), usage of a radio communication technology called LPWA (Low Power Wide Area) with which communication in a wide area is possible at low power consumption has been contemplated.

The operation of LPWA in an unlicensed band (for example, 920 MHz band) has been contemplated. LPWA provides a plurality of modes (standards). For example, the communication modes of LPWA include a first communication mode in which communication is performed by using a spread spectrum mode and a second communication mode in which communication is performed without using a spread spectrum mode. The first communication mode includes, for example, a communication mode called “LoRa”. The second communication mode includes, for example, a communication mode called “Wi-SUN (Wireless Smart Utility Network)”.

Hereinafter, the communication mode called “LoRa” (hereinafter, described as “LoRa mode”) is described as one example of the first communication mode, and the communication mode called “Wi-SUN” (hereinafter, described as “Wi-SUN mode”) is described as one example of the second communication mode. The present disclosure is not limited to the LoRa mode or the Wi-SUN mode.

Hereinafter, a terminal that operates in accordance with the LoRa mode (that supports the LoRa mode) is described as “LoRa terminal”, and a terminal that operates in accordance with the Wi-SUN mode (that supports the Wi-SUN mode) is described as “Wi-SUN terminal”.

LPWA terminals are not limited to terminals owned by users and are mounted on various devices. For example, LPWA terminals are mounted on home appliances, such as televisions, air conditioners, laundry machines, and refrigerators, and mobile transportation, such as vehicles.

Not only LPWA but also various systems including, for example, Wi-fi (registered trademark), RFID (Radio Frequency IDentifier), and the like use unlicensed bands.

For this reason, when, for example, a channel to be used for communication by an LPWA terminal, such as a LoRa terminal and a Wi-SUN terminal, is assigned, it is desired to consider interference from the same system and other systems.

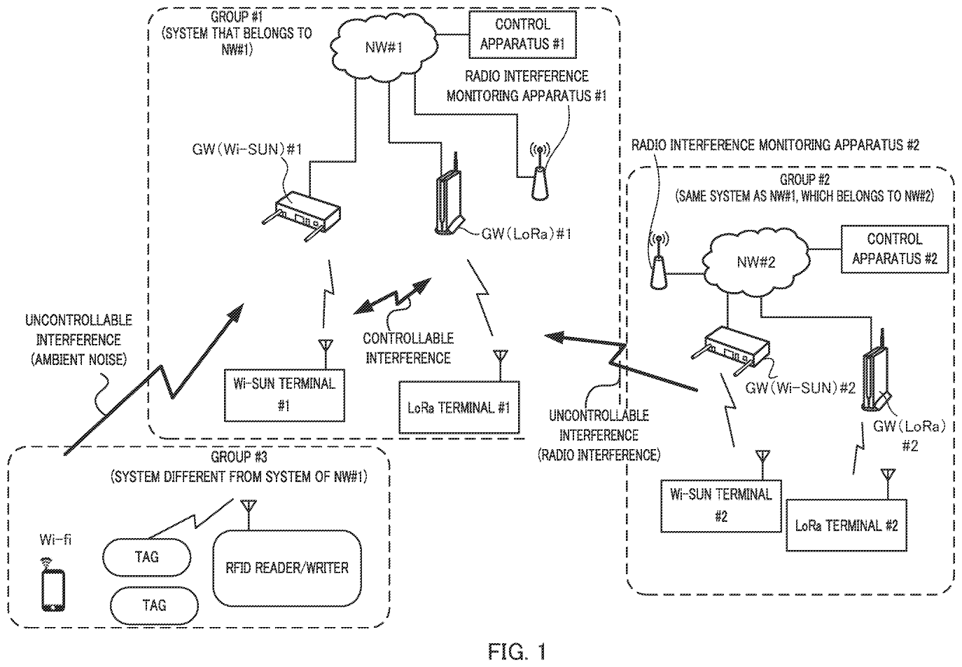

FIG. 1 is a diagram showing the outline of radio systems including LPWA.

FIG. 1 shows group #1, group #2, and group #3. Each group includes a plurality of apparatuses.

Group #1 and group #2 both are LPWA systems. Network #1 (NW #1) to which the apparatuses of group #1 belong is different from network #2 (NW #2) to which the apparatuses of group #2 belong. For example, NW #1 and NW #2 are the same LPWA systems and are networks that are operated by business operators different from each other. The LPWA system of group #2 is a radio system in a network not managed by group #1 (uncontrollable network).

Group #1 includes apparatuses that belong to NW #1 and that are connected to NW #1 by wire or radio. For example, group #1 includes Wi-SUN gateway #1 (GW(Wi-SUN) #1) and Wi-SUN terminal #1 that support communication in the Wi-SUN mode, LoRa gateway #1 (GW(LoRa) #1) and LoRa terminal #1 that support communication in the LoRa mode, and radio interference monitoring apparatus #1 that measures interference. Group #1 includes control apparatus #1 that performs centralized control over the GWs and the like via NW #1.

Group #2 includes apparatuses that belong to NW #2 and that are connected to NW #2 by wire or radio. For example, group #2 includes Wi-SUN gateway #2 (GW(Wi-SUN) #2), Wi-SUN terminal #2, LoRa gateway #2 (GW(LoRa) #2), LoRa terminal #2, and radio interference monitoring apparatus #2. Group #2 includes control apparatus #2 that performs centralized control over the GWs and the like via NW #2.

The number of apparatuses in each of group #1 and group #2 in FIG. 1 is one example, and the present disclosure is not limited thereto. For example, the number of radio interference monitoring apparatuses, GWs, or terminals included in each of group #1 and group #2 in FIG. 1 may be two or more. Another apparatus may be connected to the NW of each group.

Group #1 may include a Wi-SUN relay station that relays radio communication between Wi-SUN gateway #1 and Wi-SUN terminal #1 and/or a LoRa relay station that relays radio communication between LoRa gateway #1 and LoRa terminal #1. The configuration is not limited to an example in which the Wi-SUN relay station and the LoRa relay station are other apparatuses. For example, group #1 may include a relay station that relays radio communication of each of Wi-SUN and LoRa. Group #2 may also include similar relay stations.

Group #3 is a radio system different from the radio system (LPWA system) of group #1. The radio system of group #3 is a radio system of an uncontrollable network not managed by group #1. The radio system of group #3 is, for example, RFID, Wi-Fi, or the like. Group #3 includes an RFID reader/writer, RFID tags, terminals that use Wi-Fi, and the like. The radio system of group #3 may include an LTE (Long Term Evolution) system, a radar system, or the like.

The network configuration and/or the configuration of the apparatuses, shown in FIG. 1, is one example, and the present disclosure is not limited thereto.

For example, FIG. 1 shows an example in which the LoRa terminal and the Wi-SUN terminal are separate terminals. Alternatively, a terminal may be capable of operating in accordance with both the LoRa mode and the Wi-SUN mode.

FIG. 1 shows an example in which the Wi-SUN gateway, the LoRa gateway, the radio interference monitoring apparatus, and the control apparatus that belong to each network are separate apparatuses. Alternatively, two or more of the Wi-SUN gateway, the LoRa gateway, the radio interference monitoring apparatus, and the control apparatus may be integrated.

In the following description, the term “base station” corresponds to an apparatus in which a Wi-SUN gateway, a LoRa gateway, and a radio interference monitoring apparatus are integrated.

Each network shown in FIG. 1 may include another apparatus different from the apparatuses shown in FIG. 1. In this case, the another apparatus may have part or all of the functions of the apparatuses shown in FIG. 1. When, for example, a relay station is provided between the base station and the Wi-SUN terminal and/or the LoRa terminal, the relay station may have the function of the radio interference monitoring apparatus. A relay station may have the functions of the Wi-SUN gateway and/or the LoRa gateway and the function of the radio interference monitoring apparatus. Alternatively, a relay station may have the function of the radio interference monitoring apparatus and does not need to have the functions of the Wi-SUN gateway and/or the LoRa gateway.

The radio apparatuses of Groups #1 to #3 use a common system band (for example, an unlicensed band). For this reason, the radio apparatuses included in each of groups #1 to #3 receive interference from the other radio apparatuses. Interference that is received by one radio apparatus included in group #1 will be described as an example.

For example, a signal transmitted or received by one radio apparatus (for example, the Wi-SUN terminal #1) included in group #1 causes interference with another radio apparatus (for example, LoRa GW #1) included in group #1. Hereinafter, interference received by one radio apparatus that belongs to NW #1 from another radio apparatus that belongs to NW #1 may be described as “controllable interference”. For example, controllable interference corresponds to interference that one radio apparatus that supports communication of the LPWA system and that belongs to NW #1 receives from another radio apparatus that supports communication of the LPWA system and that belongs to NW #1.

For example, a signal transmitted or received by one radio apparatus (for example, Wi-SUN terminal #2 and/or the RFID reader/writer) included in group #2 and/or group #3 causes interference with one radio apparatus (for example, LoRa terminal #1) included in group #1. Hereinafter, interference that one radio apparatus that belongs to NW #1 receives from one radio apparatus that does not belong to NW #1 may be described as “uncontrollable interference”. For example, uncontrollable interference corresponds to interference that one radio apparatus that supports communication of the LPWA system and that belongs to NW #1 receives from one radio apparatus that does not belong to NW #1.

Uncontrollable interference is further classified in accordance with a factor of interference.

For example, a signal transmitted or received by one radio apparatus (for example, Wi-SUN terminal #2) included in group #2 causes interference with one radio apparatus (for example, LoRa terminal #1) included in group #1. Hereinafter, interference that one radio apparatus that belongs to NW #1 receives from one radio apparatus that belongs to NW #2 may be described as “radio interference” of “uncontrollable interference”. For example, “radio interference” corresponds to interference that one radio apparatus that supports communication of the LPWA system and that belongs to NW #1 receives from one radio apparatus that supports communication of the LPWA system and that belongs to NW #2 different from NW #1.

For example, a signal transmitted or received by one radio apparatus (for example, the RFID reader/writer) included in group #3 causes interference with one radio apparatus (for example, LoRa terminal #1) included in group #1. Hereinafter, interference that one radio apparatus that supports communication of the LPWA system and that belongs to NW #1 receives from one radio apparatus that supports a radio system different from the LPWA system may be described as “ambient noise” of “uncontrollable interference”.

As shown in FIG. 1 as an example, the LPWA system uses a common system band with a radio system different from the LPWA system and/or the same LPWA system that belongs to a different network. For this reason, in assigning a channel to an LPWA terminal, such as a LoRa terminal and a Wi-SUN terminal, it is desired to detect (monitor) interference and provide notification of a detected result to, for example, an apparatus that assigns a channel.

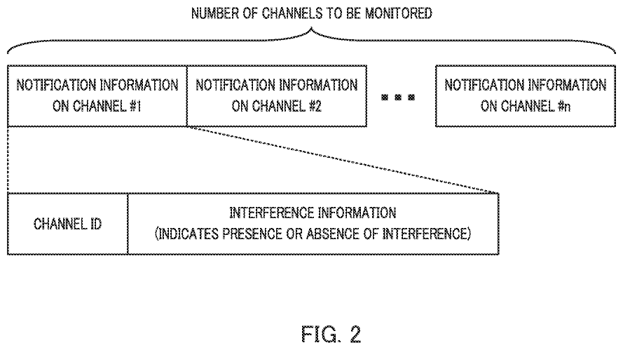

FIG. 2 is a view showing an example of the format of notification information for providing notification of an interference detection result.

The format of notification information, shown in FIG. 2, includes the fields of pieces of notification information respectively associated with channels, that is, channel #1 to channel #n. Channel #1 to channel #n are included in the system band and are one example of channels to be monitored for interference.

Information on interference in channel #1 is set in the “notification information on channel #1” field. Similarly, pieces of information on interference in channel #2 to channel #n are respectively set in the “notification information on channel #2” field to the “notification information on channel #n” field. n denotes the number of channels to be monitored. The format of notification information, shown in FIG. 2, includes the fields of pieces of notification information, corresponding to the number of channels to be monitored.

The “notification information on channel #1” field includes a “channel ID” field and an “interference information” field.

An identifier (for example, channel number) for identifying a channel is set in the “channel ID” field.

A detection result (monitoring result) of an interference amount is set in the “interference information” field. For example, information indicating the presence or absence of interference is set in the “interference information” field. Information indicating the presence or absence of interference, for example, indicates that there is interference when a detected interference amount is greater than a threshold and indicates that there is no interference when a detected interference amount is less than or equal to the threshold. For example, in the “interference information” field having a size of one bit, “1” is set when there is interference, and “0” is set when there is no interference.

The format of notification information, shown in FIG. 2, includes information indicating the presence or absence of interference and does not include information other than the presence or absence of interference, so there is a possibility that notification using the format shown in FIG. 2 is not sufficient to appropriately assign a channel. When a channel is not appropriately assigned, it is difficult to optimize the network that uses the system band, and there is a possibility that the efficiency of use of frequency in the system band decreases.

Among the above-described types of interference, for example, uncontrollable interference received by one radio apparatus that belongs to NW #1 is interference received from one radio apparatus that does not belong to NW #1, so it is difficult for NW #1 (for example, the control apparatus of NW #1) to manage or control the interference. On the other hand, controllable interference received by one radio apparatus that belongs to NW #1 is interference from one radio apparatus that belongs to NW #1, so it is possible for NW #1 to manage and control the interference.

Non-limiting embodiments of the present disclosure achieves appropriate notification of an interference detection result in a band used by various radio communication systems by classifying detected interference and generating notification information for providing notification of a detection result of the classified interference.

<Configuration Example of Base Station>

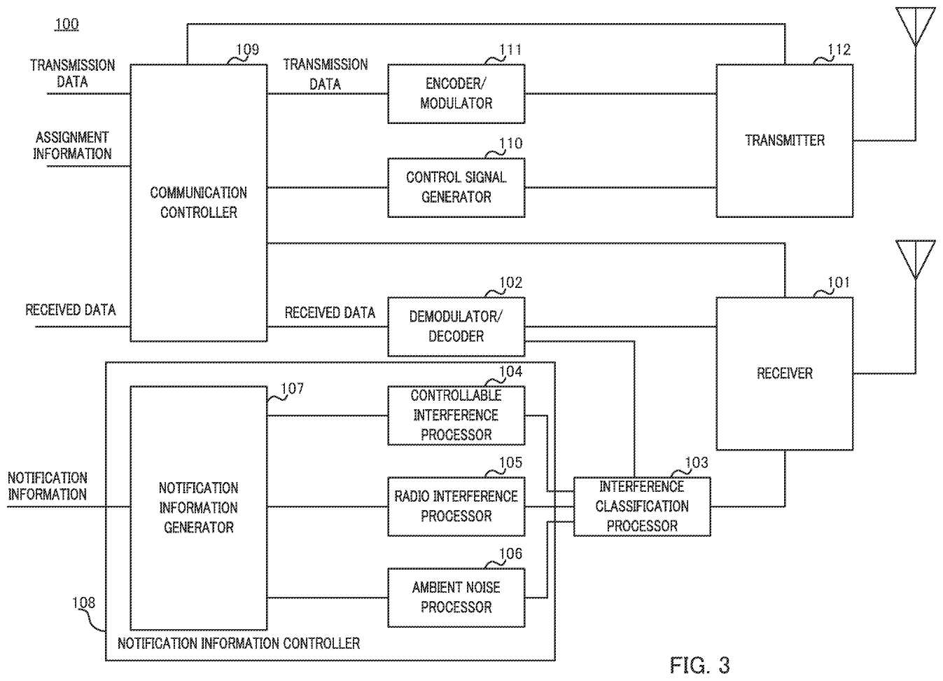

FIG. 3 is a block diagram showing a configuration example of base station 100 according to the present embodiment. Base station 100, for example, belongs to NW #1 shown in FIG. 1 and has the functions of the Wi-SUN GW, the LoRa GW, and the radio interference monitoring apparatus.

Base station 100 includes receiver 101, demodulator/decoder 102, interference classification processor 103, controllable interference processor 104, radio interference processor 105, ambient noise processor 106, notification information generator 107, communication controller 109, control signal generator 110, encoder/modulator 111, and transmitter 112.

Receiver 101 receives a signal transmitted by a terminal (the LoRa terminal and/or the Wi-SUN terminal (see FIG. 1)) and executes a predetermined reception process on the received signal. For example, the predetermined reception process includes a frequency conversion process (down-conversion) based on the frequency of a channel assigned to the terminal. Information on the frequency of the channel assigned to the terminal may be acquired from, for example, communication controller 109.

Receiver 101 receives a signal in each channel usable in a system band (for example, each channel included in an unlicensed band) for interference measurement (radio interference monitoring). Receiver 101 executes the predetermined reception process on the received signal. The predetermined reception process includes, for example, a frequency conversion process based on the frequency of each channel.

Receiver 101 outputs a received signal, subjected to the predetermined reception process, to demodulator/decoder 102 and interference classification processor 103.

Demodulator/decoder 102 executes a demodulation process and a decoding process on the received signal acquired from receiver 101 and generates received data. Received data may include an identifier for identifying a terminal that belongs to the same NW (NW #1) as that of the base station 100. When the terminal that is the source of a received signal is a LoRa terminal, the demodulation process may include a inverse spread process for spread spectrum used in the LoRa mode.

Interference classification processor 103, for example, classifies interference in each channel. For example, interference classification processor 103 monitors a received signal in a predetermined time in one channel and classifies the above-described controllable interference from the received signal (interference signal). Interference classification processor 103 may classify a received signal into controllable interference and interference including uncontrollable interference. Interference including uncontrollable interference is, for example, a received interference signal (interference before classification). Alternatively, interference classification processor 103 may classify a received signal into controllable interference and uncontrollable interference. Notification information generated by notification information generator 107 (described later) includes, for example, information according to an interference classification result.

Interference classification processor 103 detects a preamble of a received signal. For example, interference classification processor 103 calculates a correlation between a received signal and a preamble used in the LoRa mode and calculates a correlation between a received signal and a preamble used in the Wi-SUN mode. Preambles respectively used in the LoRa mode and the Wi-SUN mode may be common regardless of the NW to which the terminal that is the source of a received signal belongs.

When both the result of the correlation between a received signal and the preamble used in the LoRa mode and the result of the correlation between a received signal and the preamble used in the Wi-SUN mode have no peak greater than or equal to a predetermined value, interference classification processor 103 determines that the source of the received signal is neither a LoRa terminal nor a Wi-SUN terminal.

When, for example, the result of the correlation between a received signal and the preamble used in the LoRa mode has a peak greater than or equal to the predetermined value, interference classification processor 103 determines that the source of the received signal is a LoRa terminal. When, for example, the result of the correlation between a received signal and the preamble used in the Wi-SUN mode has a peak greater than or equal to the predetermined value, interference classification processor 103 determines that the source of the received signal is a Wi-SUN terminal.

Preambles respectively used in the LoRa mode and the Wi-SUN mode are common regardless of the NW to which the terminal that is the source of a received signal belongs. For this reason, when interference classification processor 103 determines that the source of a received signal is a LoRa terminal or a Wi-SUN terminal, interference classification processor 103 determines whether the NW to which the source belongs is the same NW (NW #1) as that of base station 100 or the NW different from that of base station 100 (for example, NW #2 in FIG. 1).

For example, interference classification processor 103 determines the NW to which the source belongs in accordance with a decoded result of a received signal acquired from demodulator/decoder 102. When, for example, a received signal is correctly decoded and the received signal includes an identifier, interference classification processor 103 determines that the NW to which the source of the received signal belongs is the same NW as that of base station 100. On the other hand, when, for example, a received signal is not correctly decoded and the received signal does not include an identifier, interference classification processor 103 determines that the NW to which the source of the received signal belongs is an NW different from that of base station 100.

When the source of a received signal is a LoRa terminal or a Wi-SUN terminal that belongs to NW #1 same as that of base station 100, interference classification processor 103 determines that the received signal corresponds to controllable interference.

On the other hand, when the source of a received signal is neither a LoRa terminal nor a Wi-SUN terminal, interference classification processor 103 determines that the received signal corresponds to uncontrollable interference.

Even when interference classification processor 103 determines that the source of a received signal is a LoRa terminal or a Wi-SUN terminal, and when the source of a received signal is a LoRa terminal or a Wi-SUN terminal that belongs to an NW different from that of base station 100, interference classification processor 103 determines that the received signal corresponds to uncontrollable interference.

Interference classification processor 103 may classify uncontrollable interference into radio interference and ambient noise.

When, for example, the source of a received signal is neither a LoRa terminal nor a Wi-SUN terminal, interference classification processor 103 determines that the source of the received signal is a radio apparatus that supports a radio system different from the LPWA system and the received signal corresponds to ambient noise.

When, for example, the source of a received signal is a LoRa terminal or a Wi-SUN terminal that belongs to an NW different from that of base station 100, interference classification processor 103 determines that the received signal corresponds to radio interference.

A classification method in interference classification processor 103 is not limited to the above-described method based on a preamble detection result of a received signal and a decoded result of the received signal.

Interference classification processor 103 may further classify controllable interference. Alternatively, interference classification processor 103 may determine a priority for ambient noise. An example of further classification of controllable interference and an example of priority determination will be described later.

Interference classification processor 103 outputs a received signal according to a classification result of interference, determined in accordance with a preamble detection result of the received signal and a decoded result of the received signal. For example, interference classification processor 103 outputs a received signal associated with controllable interference to controllable interference processor 104, outputs a received signal associated with radio interference to radio interference processor 105, and outputs a received signal associated with ambient noise to ambient noise processor 106.

Controllable interference processor 104 determines the interference amount of controllable interference from a received signal associated with controllable interference. Controllable interference processor 104 outputs the interference amount of controllable interference to notification information generator 107.

Radio interference processor 105 determines the interference amount of radio interference from a received signal associated with radio interference. Radio interference processor 105 outputs the interference amount of radio interference to notification information generator 107.

Ambient noise processor 106 determines the interference amount of ambient noise from a received signal associated with ambient noise. Ambient noise processor 106 outputs the interference amount of ambient noise to notification information generator 107.

A manner to represent an interference amount is not limited. For example, an interference amount may be represented by a mean, minimum, or maximum of received signal power (which may also be referred to as interference power). Alternatively, an interference amount may be represented by using the relationship between a received signal power and a time interval (which may also be referred to as monitoring interval) in which a received signal is received. For example, an interference amount may be represented by, for example, a time interval in which a received signal power has a value higher than or equal to a predetermined value or may be represented by, for example, whether a time interval in which a received signal power has a value higher than or equal to a predetermined value is longer than or equal to a predetermined length. Manners to respectively represent the interference amounts of controllable interference, radio interference, and ambient noise may be different from one another or may be common to one another.

Notification information generator 107 generates notification information on interference in each channel in accordance with the interference amount of controllable interference, the interference amount of radio interference, and the interference amount of ambient noise. The format of notification information and an example of notification information will be described later.

When interference classification processor 103 does not classify uncontrollable interference into radio interference and ambient noise, interference classification processor 103 may output a received signal associated with uncontrollable interference to radio interference processor 105. In this case, radio interference processor 105 determines the interference amount of uncontrollable interference from a received signal associated with uncontrollable interference and outputs the interference amount of uncontrollable interference to notification information generator 107. In this case, notification information generator 107 generates notification information on interference in each channel in accordance with the interference amount of controllable interference and the interference amount of uncontrollable interference.

Notification information generator 107 transmits the generated notification information to the control apparatus (see FIG. 1) of NW #1 via, for example, NW #1.

Controllable interference processor 104, radio interference processor 105, ambient noise processor 106, and notification information generator 107 may be collectively referred to as notification information controller 108.

Communication controller 109 acquires assignment information on channels assigned to terminals from control apparatus #1 (see FIG. 1) of NW #1.

Communication controller 109 outputs assignment information to control signal generator 110.

Communication controller 109 executes control on data communication with a terminal. For example, communication controller 109 may output received data acquired from demodulator/decoder 102 to a host station (not shown) (for example, the control apparatus in FIG. 1) or another apparatus in NW #1. Communication controller 109 outputs transmission data for a terminal, acquired from a host station or another apparatus in NW #1, to encoder/modulator 111.

Control signal generator 110 generates a control signal for a terminal in accordance with information acquired from communication controller 109. Control signal generator 110 outputs a control signal subjected to predetermined signal processing (for example, an encoding process and a modulation process) to transmitter 112.

Encoder/modulator 111 generates a transmission signal by executing the encoding process and the modulation process on transmission data acquired from communication controller 109. Encoder/modulator 111 outputs a transmission signal to transmitter 112. When the terminal that is the destination of a transmission signal is a LoRa terminal, the modulation process may include a spread spectrum process used in the LoRa mode.

Transmitter 112 executes a predetermined transmission process on a transmission signal acquired from encoder/modulator 111. For example, the predetermined transmission process includes a frequency conversion process (up-conversion) based on the frequency of a channel assigned to a terminal. Assignment information on the frequency of the channel assigned to the terminal may be acquired from, for example, communication controller 109.

Transmitter 112 executes a predetermined transmission process on a control signal acquired from control signal generator 110. For example, the predetermined transmission process includes a frequency conversion process (up-conversion) based on the frequency of a channel for transmitting a control signal to a terminal. A channel for transmitting a control signal to a terminal may be, for example, a predetermined channel or may be a channel used at current point in time in communication with a terminal.

In the above description, an example in which the components shown in FIG. 3 are included in one base station 100 has been described. The present disclosure is not limited thereto. For example, any one of two or more apparatuses may include each of the components shown in FIG. 3.

For example, the components of base station 100 shown in FIG. 3 may be separated into a first apparatus that has the function of the Wi-SUN GW and the function of the LoRa GW and a second apparatus that has the function of the radio interference monitoring apparatus.

In this case, the first apparatus includes, for example, receiver 101, demodulator/decoder 102, communication controller 109, control signal generator 110, encoder/modulator 111, and transmitter 112. The second apparatus (radio interference monitoring apparatus) includes receiver 101 that receives a signal for interference measurement (radio interference monitoring), interference classification processor 103, controllable interference processor 104, radio interference processor 105, ambient noise processor 106, and notification information generator 107. In this case, the first apparatus and the second apparatus may be connected via an NW or may be directly connected by radio or wire.

In this case, for example, the second apparatus may acquire a decoded result of a received signal in the first apparatus or may output notification information generated by the second apparatus to the first apparatus. For example, the second apparatus may be configured to acquire a received signal received by receiver 101 of the first apparatus, instead of including receiver 101.

The first apparatus may execute both signal processing on a signal transmitted to or received from the LoRa terminal and signal processing on a signal transmitted to or received from the Wi-SUN terminal. Alternatively, the first apparatus that executes signal processing on a signal transmitted to or received from the LoRa terminal and the first apparatus that executes signal processing on a signal transmitted to or received from the Wi-SUN terminal may be separately provided.

The first apparatus may assign a channel to a terminal in accordance with notification information provided from the second apparatus. In this case, notification information does not need to be provided to the control apparatus via the NW.

The functional blocks of the second apparatus may be included in a relay station that relays communication in the LoRa mode and/or the Wi-SUN mode. Alternatively, the second apparatus may be connected to a relay station and operate.

<Example of Notification Information>

Next, an example of notification information generated in notification information generator 107 of base station 100 described above will be described.

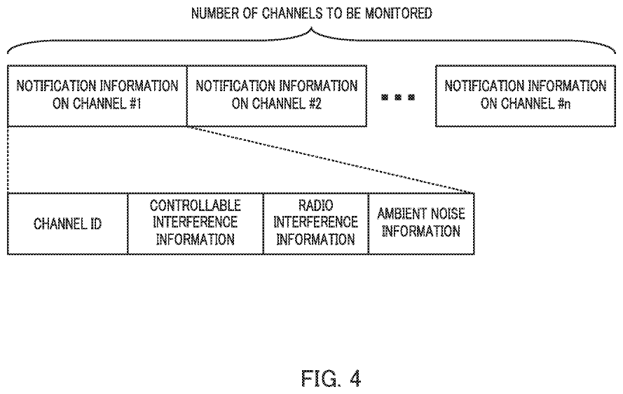

FIG. 4 is a view showing a first example of the format of notification information according to the present embodiment.

The format of notification information shown in FIG. 4 includes the fields for setting pieces of notification information respectively associated with channels, that is, channel #1 to channel #n.

Information on interference in channel #1 is set in the “notification information on channel #1” field. Similarly, pieces of information on interference in channel #2 to channel #n are respectively set in the “notification information on channel #2” field to the “notification information on channel #n” field. n denotes the number of channels to be monitored. The format of notification information shown in FIG. 4 includes the fields of pieces of notification information, corresponding to the number of channels to be monitored.

The “notification information on channel #1” field includes a “channel ID” field, a “controllable interference information” field, a “radio interference” field, and an “ambient noise” field.

An identifier (for example, channel number) for identifying a channel is set in the “channel ID” field.

Information on controllable interference, for example, a detection result of the interference amount of controllable interference, is set in the “controllable interference information” field. For example, information indicating the presence or absence of controllable interference is set in the “controllable interference information” field. Information indicating the presence or absence of controllable interference, for example, indicates that there is controllable interference when a detected interference amount of controllable interference is greater than a predetermined value and indicates that there is no controllable interference when a detected interference amount of controllable interference is less than or equal to the predetermined value. For example, in the “controllable interference information” field having a size of one bit, “1” is set when there is controllable interference, and “0” is set when there is no controllable interference.

Information on radio interference, for example, a detection result of the interference amount of radio interference, is set in the “radio interference information” field. For example, information indicating the presence or absence of radio interference is set in the “radio interference information” field. Information indicating the presence or absence of radio interference, for example, indicates that there is radio interference when a detected interference amount of radio interference is greater than a predetermined value and indicates that there is no radio interference when a detected interference amount of radio interference is less than or equal to the predetermined value. For example, in the “radio interference information” field having a size of one bit, “1” is set when there is radio interference, and “0” is set when there is no radio interference.

Information on ambient noise, for example, a detection result of the interference amount of ambient noise, is set in the “ambient noise information” field. For example, information indicating the presence or absence of ambient noise is set in the “ambient noise information” field. Information indicating the presence or absence of ambient noise, for example, indicates that there is ambient noise when a detected interference amount of ambient noise is greater than a threshold and indicates that there is no ambient noise when a detected interference amount of ambient noise is less than or equal to the threshold. For example, in the “ambient noise information” field having a size of one bit, “1” is set when there is ambient noise, and “0” is set when there is no ambient noise.

In the format of notification information shown in FIG. 4, interference is classified, and information on the classified interference is set separately. For example, base station 100 provides notification of information on each classified interference by using the format shown in FIG. 4.

In the following description, for example, setting information on controllable interference in the “controllable interference information” field may be described as “generating controllable interference information”. Radio interference information and ambient noise information may also be similarly described as controllable interference information.

In the above-described example, an example in which the interference amount of controllable interference is compared with one predetermined value and the presence or absence of controllable interference is determined has been described. The present disclosure is not limited thereto. For example, the interference amount of controllable interference may be compared with a plurality of predetermined values, and the interference amount of controllable interference may be classified by stage (classified by level). In this case, information on controllable interference may be information indicating the level of controllable interference. Information on radio interference may also be information indicating the level of radio interference as in the case of information on controllable interference. Information on ambient noise may also be information indicating the level of ambient noise as in the case of information on controllable interference.

When, for example, information on controllable interference indicates the level of controllable interference, the “controllable interference information” field may have at least a size of the number of bits corresponding to the number of levels of controllable interference. When, for example, the level of controllable interference indicates any one of four levels “0”, “1”, “2”, and “3”, the “controllable interference information” field may have at least a size of two bits. In this case, four logical patterns (0, 0), (0, 1), (1, 0), and (1, 1) using two bits may be associated with the four levels “0” to “3”. When information on radio interference indicates the level of radio interference or when information on ambient noise indicates the level of ambient noise as well, the associated field may similarly have at least a size of the number of bits corresponding to the number of levels.

The number of predetermined values to be compared with the interference amount of controllable interference, the number of predetermined values to be compared with the interference amount of radio interference, and the number of thresholds to be compared with the interference amount of ambient noise are not limited. For example, the number of thresholds to be compared with the interference amount of ambient noise may be greater than the number of predetermined values to be compared with the interference amount of controllable interference and/or the number of predetermined values to be compared with the interference amount of radio interference.

FIG. 4 shows an example in which the number of “ambient noise information” fields is one. Notification of information on ambient noise may be provided by using a method different from that of information on controllable interference or information on radio interference. For example, notification of information on ambient noise may be provided by using a plurality of fields.

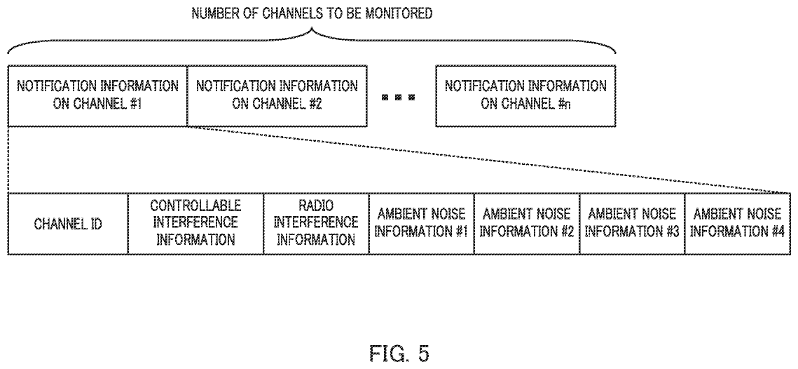

FIG. 5 is a view showing a second example of the format of notification information according to the present embodiment. In the format shown in FIG. 5, the description of fields similar to those of the format shown in FIG. 4 is omitted.

The difference in format between FIG. 4 and FIG. 5 is that the format of FIG. 4 includes one “ambient noise information” field, whereas the format of FIG. 5 includes four “ambient noise information” fields.

Associated four thresholds and pieces of information based on a compared result of the interference amount of ambient noise are respectively set in the “ambient noise information #1” field to the “ambient noise information #4” field.

Hereinafter, four thresholds are described as threshold #1 to threshold #4. Among the four thresholds, the relationship threshold #1<threshold #2<threshold #3<threshold #4 holds. Threshold #1 to threshold #4 are respectively associated with the “ambient noise information #1” field to the “ambient noise information #4” field.

Information indicating the presence or absence of ambient noise in determination based on threshold #1 is set in the “ambient noise information #1” field. Information indicating the presence or absence of ambient noise in determination based on threshold #1, for example, indicates that there is ambient noise when the interference amount of ambient noise is greater than threshold #1 and indicates that there is no interference when the interference amount of ambient noise is less than or equal to threshold #1. For example, in the “ambient noise information #1” field having a size of one bit, “1” is set when there is ambient noise, and “0” is set when there is no ambient noise.

In each of the “ambient noise information #2” field to the “ambient noise information #4” field, as in the case of the “ambient noise information #1” field, information indicating the presence or absence of ambient noise in determination based on an associated one of the thresholds (threshold #2 to threshold #4) is set.

For example, comparison determination of the interference amount of ambient noise with threshold #1 to threshold #4 corresponds to classifying the interference amount of ambient noise into five levels. For example, the interference amount of ambient noise, less than or equal to threshold #1, may be described as “ambient noise level 0”. Similarly, the interference amount of ambient noise, greater than threshold #1 and less than or equal to threshold #2, may be described as “ambient noise level 1”, the interference amount of ambient noise, greater than threshold #2 and less than or equal to threshold #3, may be described as “ambient noise level 2”, the interference amount of ambient noise, greater than threshold #3 and less than or equal to threshold #4, may be described as “ambient noise level 3”, and the interference amount of ambient noise, greater than threshold #4” may be described as “ambient noise level 4”.

For example, threshold #1 to threshold #4 may be set according to the communication mode of a terminal to which a channel is assigned and a set transmission power in the communication mode. As an example, the case where the communication mode of a terminal to which a channel is assigned is the Wi-SUN mode or LoRa mode of the LPWA system and a transmission power is set to a normal transmission power or a transmission power higher than the normal transmission power will be described.

For example, threshold #1 is set in accordance with an electric power at which communication is possible by using a communication mode in which a normal transmission power is set in the Wi-SUN mode (hereinafter, described as “mode a”). With this setting, when, for example, the interference amount of ambient noise in channel #1 is less than or equal to threshold #1, a terminal that employs mode a is allowed to be assigned to channel #1.

For example, threshold #2 is set in accordance with an electric power at which a terminal that employs a communication mode in which a transmission power higher than the normal transmission power is set in the Wi-SUN mode (hereinafter, described as “mode b”) is capable of communication. With this setting, when, for example, the interference amount of ambient noise in channel #1 is less than or equal to threshold #2, the terminal that employs mode b is allowed to be assigned to channel #1.

For example, threshold #3 is set in accordance with an electric power at which a terminal that employs a communication mode using the LoRa mode with the normal transmission power (hereinafter, described as “mode c”) is capable of communication. With this setting, when, for example, the interference amount of ambient noise in channel #1 is less than or equal to threshold #3, the terminal that employs mode c is allowed to be assigned to channel #1.

For example, threshold #4 is set in accordance with an electric power at which a terminal that employs a communication mode using the LoRa mode with a transmission power higher than the normal transmission power (hereinafter, described as “mode d”) is capable of communication. With this setting, when, for example, the interference amount of ambient noise in channel #1 is less than or equal to threshold #4, the terminal that employs mode d is assigned to channel #1. With this setting, when, for example, the interference amount of ambient noise in channel #1 is greater than threshold #4, the terminal that employs mode d and the terminals that respectively employ mode a to mode c are not assigned to channel #1.

Among the above-described mode a to mode d, the mode most resistant to ambient noise is mode d, and resistance to ambient noise decreases in order of mode c, mode b, and mode a. For example, a terminal that employs a mode having a higher resistance to ambient noise than mode x (x is any one of a to d) may be assigned to a channel to which a terminal that employs mode x can be assigned.

In the format shown in FIG. 5, notification different from the above-described controllable interference or radio interference is possible by providing a plurality of fields in association with notification of ambient noise information.

FIG. 5 shows an example in which four “ambient noise information” fields for providing notification of four pieces of ambient noise information. The present disclosure is not limited thereto. For example, the number of “ambient noise information” fields may be set to less than or equal to three or may be set to greater than or equal to five. When, for example, L “ambient noise information” fields are included, L thresholds respectively associated with the fields may be set. In this case, a determined result based on an associated threshold may be set in each of the L “ambient noise information” fields.

When, for example, the number of “ambient noise information” fields is set to greater than four (for example, eight), information in which the interference amount of ambient noise is further minutely classified by level can be provided. With an increase in the type of ambient noise information to be provided as notification, the information content of ambient noise information (for example, the number of “ambient noise information” fields) increases, so the type of ambient noise information and the information content of ambient noise information are in a trade-off relationship.

The number of “ambient noise information” fields and/or the number of thresholds may be set according to the number of communication modes of a terminal to which a channel is assigned and/or a set transmission power in each communication mode.

<Example of Flow of Generating Notification Information>

An example of a process flow in base station 100 to generate notification information in the above-described format of FIG. 5 will be described.

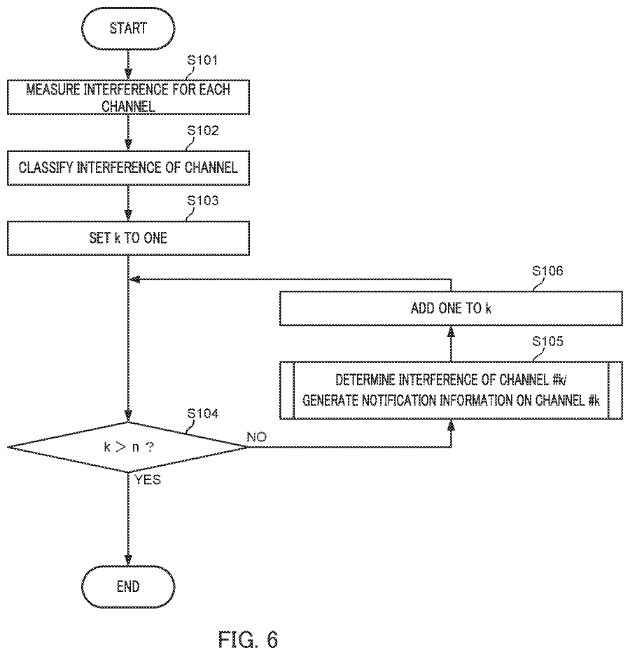

FIG. 6 is a flowchart showing a first example of a notification information generating process according to the present embodiment.

Base station 100 measures interference in each channel (S101).

Base station 100 classifies the interference measured in each channel (S102).

From S103, notification information on each of the channels is generated.

Base station 100 sets k to one (S103). k is the index of a channel associated with the identification number of the channel.

Base station 100 determines whether k is greater than n (S104). n denotes the number of channels to be monitored. In other words, in S104, it is determined whether generation of pieces of notification information on all the channels to be monitored is complete.

When k is not greater than n (NO in S104), that is, when generation of pieces of notification information on all the channels to be monitored is not complete, base station 100 determines interference in channel #k and generates notification information on channel #k (S105). A process in S105 will be described later.

Base station 100 adds one to k (S106). The flow returns to the process of S104.

When k is greater than n (YES in S104), that is, when generation of pieces of notification information on all the channels to be monitored is complete, the flow shown in FIG. 6 ends.

<Example of Flow of Process in S105>

Next, the flow of a process to be executed in S105 of FIG. 6 will be described.

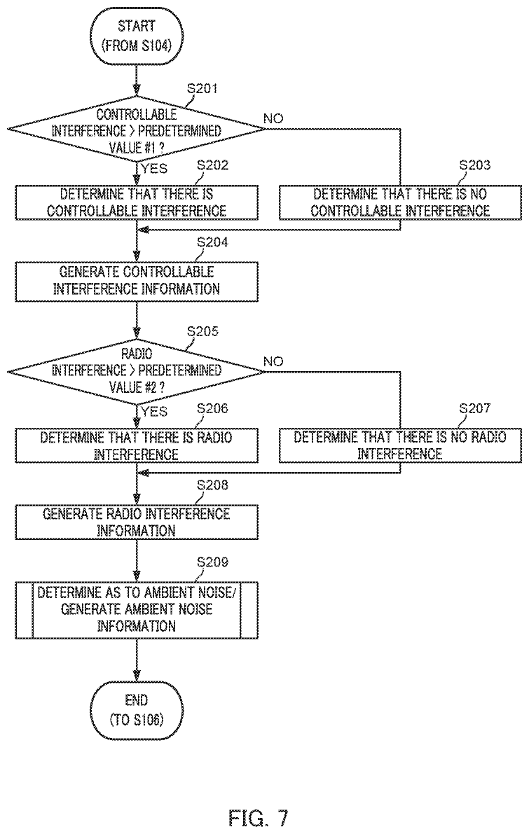

FIG. 7 is a flowchart showing a first example of a process to be executed in S105 of FIG. 6.

Base station 100 determines whether the interference amount of controllable interference is greater than predetermined value #1 (S201).

When the interference amount of controllable interference is greater than predetermined value #1 (YES in S201), base station 100 determines that there is controllable interference (S202).

When the interference amount of controllable interference is not greater than predetermined value #1 (NO in S201), base station 100 determines that there is no controllable interference (S203).

Base station 100 generates controllable interference information in accordance with the determined result of S202 or S203 (S204).

Base station 100 determines whether the interference amount of radio interference is greater than predetermined value #2 (S205).

When the interference amount of radio interference is greater than predetermined value #2 (YES in S205), base station 100 determines that there is radio interference (S206).

When the interference amount of radio interference is not greater than predetermined value #2 (NO in S205), base station 100 determines that there is no radio interference (S207).

Base station 100 generates controllable interference information in accordance with the determined result of S206 or S207 (S208).

Base station 100 performs determination as to ambient noise and generates ambient noise information (S209). A process in S209 will be described later.

When the process of S209 is complete, generation of notification information on channel #k is complete, and the flow of FIG. 7 ends. For example, in this case, the process proceeds to S106 in the flow of FIG. 6.

<Example of Flow of Process in S209>

Next, the flow of a process to be executed in S209 of FIG. 7 will be described.

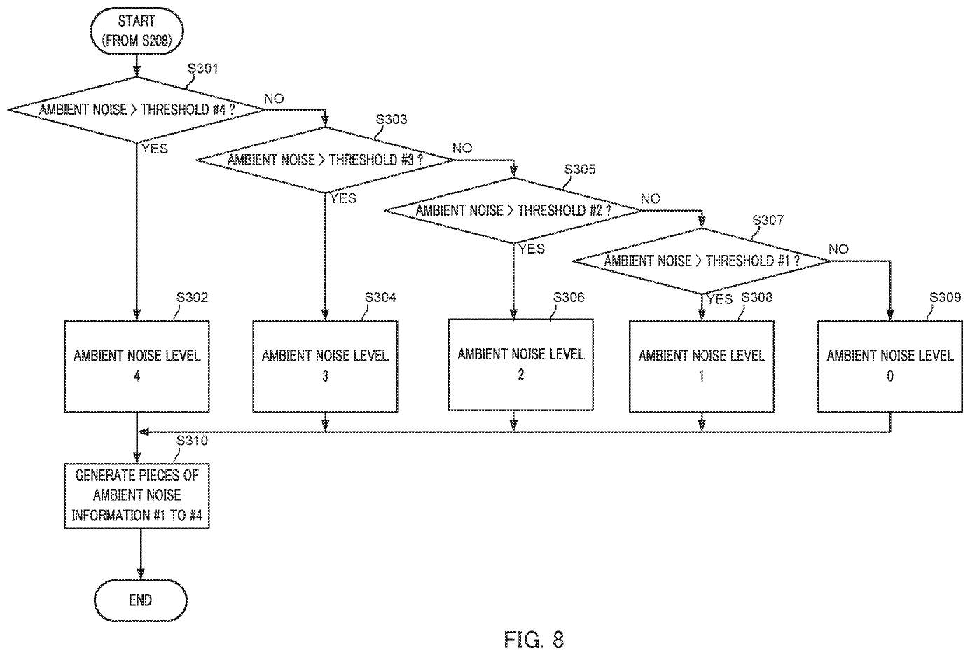

FIG. 8 is a flowchart showing a first example of a process to be executed in S209 of FIG. 7.

Base station 100 determines whether the interference amount of ambient noise is greater than threshold #4 (S301).

When base station 100 determines that the interference amount of ambient noise is greater than threshold #4 (YES in S301), base station 100 determines that an ambient noise level in channel #k is level 4 (S302).

When, for example, the ambient noise level in channel #k is determined as level 4, it may be determined that communication is not possible in channel #k.

When the interference amount of ambient noise is not greater than threshold #4 (NO in S301), base station 100 determines whether the interference amount of ambient noise is greater than threshold #3 (S303).

When the interference amount of ambient noise is greater than threshold #3 (YES in S303), base station 100 determines that the ambient noise level in channel #k is level 3 (S304).

For example, the case where the ambient noise level in channel #k is determined as level 3 is the case where the interference amount of ambient noise is less than or equal to threshold #4 and greater than threshold #3. In this case, it may be determined that communication is possible at a transmission power higher than the normal transmission power by using the LoRa mode in channel #k.

When the interference amount of ambient noise is not greater than threshold #3 (NO in S303), base station 100 determines whether the interference amount of ambient noise is greater than threshold #2 (S305).

When the interference amount of ambient noise is greater than threshold #2 (YES in S305), base station 100 determines that the ambient noise level in channel #k is level 2 (S306).

For example, the case where the ambient noise level in channel #k is determined as level 2 is the case where the interference amount of ambient noise is less than or equal to threshold #3 and greater than threshold #2. In this case, it may be determined that communication is possible at the normal transmission power by using the LoRa mode in channel #k.

When the interference amount of ambient noise is not greater than threshold #2 (NO in S305), base station 100 determines whether the interference amount of ambient noise is greater than threshold #1 (S307).

When the interference amount of ambient noise is greater than threshold #1 (YES in S307), base station 100 determines that the ambient noise level in channel #k is level 1 (S308).

For example, the case where the ambient noise level in channel #k is determined as level 1 is the case where the interference amount of ambient noise is less than or equal to threshold #2 and greater than threshold #1. In this case, it may be determined that communication is possible at a transmission power higher than the normal transmission power by using the Wi-SUN mode in channel #k.

When the interference amount of ambient noise is not greater than threshold #1 (NO in S307), base station 100 determines that the ambient noise level in channel #k is level 0 (S309).

For example, the case where the ambient noise level in channel #k is determined as level 0 is the case where the interference amount of ambient noise is less than or equal to threshold #1. In this case, it may be determined that communication is possible at the normal transmission power by using the Wi-SUN mode in channel #k.

Subsequently, pieces of ambient noise information #1 to #4 are generated in accordance with the ambient noise level determined in S302, S304, S306, S308, or S309 (S310). The flow of FIG. 8 ends.

The flow of FIG. 8 shows an example in which the interference amount of ambient noise and thresholds are compared in descending order of threshold. The order of comparison is not limited thereto. For example, the interference amount of ambient noise and thresholds may be compared in ascending order of threshold (for example, in order of threshold #1 to threshold #4).

Thus, in the flows of the processes shown in FIGS. 6, 7, and 8, for example, notification information having the format shown in FIG. 5 is generated.

In one embodiment of the above-described present embodiment, interference classification processor 103 in base station 100 that supports the LPWA system and that belongs to NW #1 classifies controllable interference from a radio apparatus that supports the LPWA system and that belongs to NW #1, radio interference from a radio apparatus that supports LPWA and that belongs to a network different from NW #1 (for example, NW #2 in FIG. 1), and ambient noise from a radio apparatus that supports a radio system different from the LPWA system. Notification information controller 108 outputs notification information including information on controllable interference, information on radio interference, and information on ambient noise to the control apparatus of NW #1.

With this configuration, interference can be classified, and notification of information on the classified interference can be separately provided, so notification of an interference detection result in a band used by various radio communication systems can be appropriately provided. With this notification, for example, channels are appropriately assigned to a terminal in a network, so it is possible to optimize the network (for example, both improvement in the efficiency of use of frequency and reduction of interference with another network and another system).

<Variation 1>

The format shown in FIG. 5 is an example including four “ambient noise information” fields. Part of the four “ambient noise information” fields may be omitted. In Variation 1, an example in which part of the four “ambient noise information” fields are omitted according to a determined result based on comparison between ambient noise and thresholds will be described.

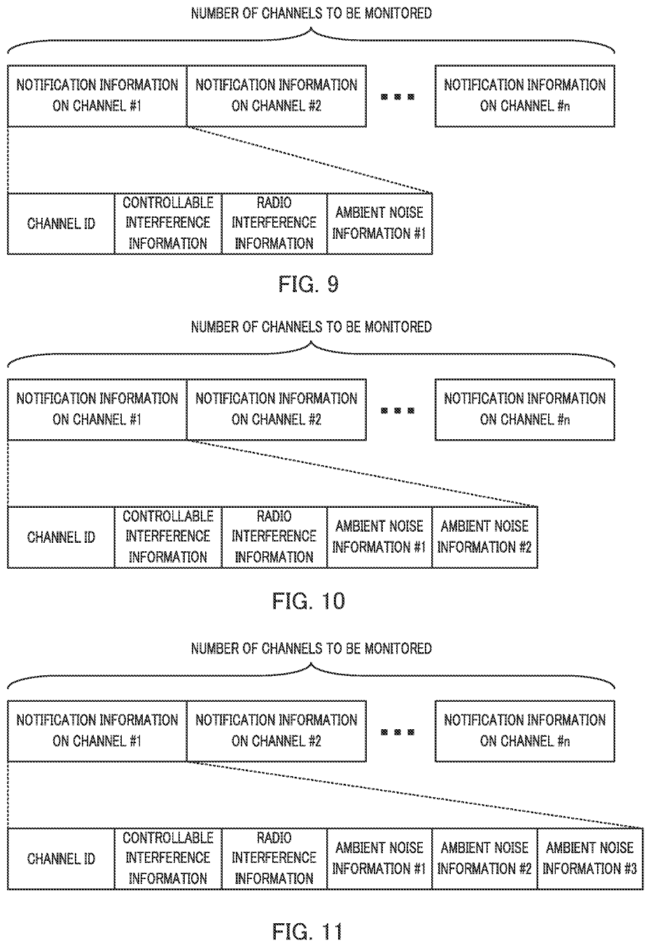

FIG. 9 is a view showing a first modification of the format of notification information, shown in FIG. 5. FIG. 10 is a view showing a second modification of the format of notification information, shown in FIG. 5. FIG. 11 is a view showing a third modification of the format of notification information, shown in FIG. 5. In the formats respectively shown in FIGS. 9 to 11, the description of fields similar to those of the formats respectively shown in FIGS. 4 and 5 is omitted.

For example, when the interference amount of ambient noise is less than or equal to threshold #1, that is, when it is determined that there is no ambient noise in determination based on threshold #1, information indicating that there is no ambient noise is set in the “ambient noise information #1” field. In this case, as shown in the format of FIG. 9, the “ambient noise information #2” field to the “ambient noise information #4” field may be omitted from the format shown in FIG. 5.

There is, for example, a case where the interference amount of ambient noise is less than or equal to threshold #2 and greater than threshold #1, that is, a case where it is determined that there is no ambient noise in determination based on threshold #2 and it is determined that there is ambient noise in determination based on threshold #1. In this case, information indicating that there is no ambient noise is set in the “ambient noise information #2” field, and information indicating that there is ambient noise is set in the “ambient noise information #1” field. In this case, as shown in the format of FIG. 10, the “ambient noise information #3” field and the “ambient noise information #4” field may be omitted from the format shown in FIG. 5.

There is, for example, a case where the interference amount of ambient noise is less than or equal to threshold #3 and greater than threshold #2, that is, a case where it is determined that there is no ambient noise in determination based on threshold #3 and it is determined that there is ambient noise in determination based on threshold #2. In this case, information indicating that there is no ambient noise is set in the “ambient noise information #3” field, and information indicating that there is ambient noise is set in the “ambient noise information #2” field. Since threshold #1 is less than threshold #2, information indicating that there is ambient noise is set in the “ambient noise information #1” field. In this case, as shown in the format of FIG. 11, the “ambient noise information #4” field may be omitted from the format shown in FIG. 5.

As illustrated in FIGS. 9 to 11, the format of notification information is partially omitted according to a determined result based on comparison between ambient noise and thresholds. Thus, the information content of notification information is reduced.

<Example of Flow According to Variation 1>

An example of the flow of an ambient noise information generating process in the case where Variation 1 in which the “ambient noise information” fields are partially omitted is applied will be described.

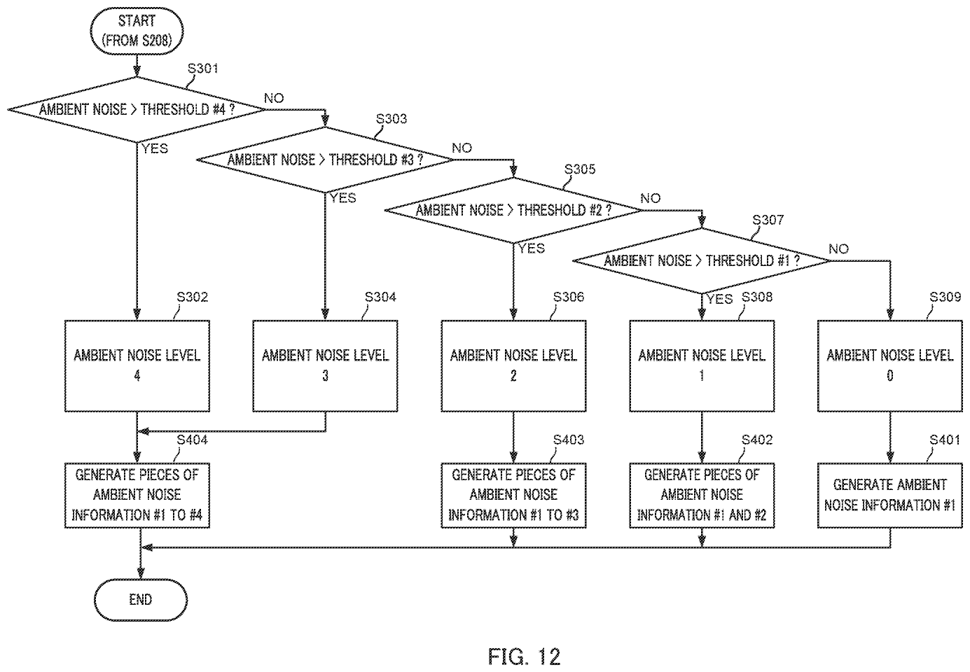

FIG. 12 is a flowchart showing a second example of a process to be executed in S209 of FIG. 7. In FIG. 12, like step numbers are assigned to processes similar to those of FIG. 8, and the description may be omitted.

The difference between FIG. 8 and FIG. 12 is that the number of pieces of ambient noise information generated (the number of “ambient noise information” fields in which information is set) is varied according to a result of level determination in FIG. 12.

After it is determined in S309 that the ambient noise level in channel #k is level 0, base station 100 generates ambient noise information #1 (S401). In this case, base station 100 does not need to generate ambient noise information #2 to ambient noise information #4, the “ambient noise information #2” field to the “ambient noise information #4” field to set these pieces of information do not need to be included in the “notification information on channel k”.

After it is determined in S308 that the ambient noise level in channel #k is level 1, base station 100 generates ambient noise information #1 and ambient noise information #2 (S402). In this case, base station 100 does not need to generate ambient noise information #3 and ambient noise information #4, the “ambient noise information #3” field and the “ambient noise information #4” field to set these pieces of information do not need to be included in the “notification information on channel k”.

After it is determined in S306 that the ambient noise level in channel #k is level 2, base station 100 generates ambient noise information #1 to ambient noise information #3 (S403). In this case, base station 100 does not need to generate ambient noise information #4, the “ambient noise information #4” field to set this information does not need to be included in the “notification information on channel k”.

After it is determined in S304 that the ambient noise level in channel #k is level 3 or after it is determined in S302 that the ambient noise level in channel #k is level 3, base station 100 generates ambient noise information #1 to ambient noise information #4 (S404). The flow of FIG. 12 ends.

The flow of FIG. 12 shows an example in which the interference amount of ambient noise and thresholds are compared in descending order of threshold. The order of comparison is not limited thereto. For example, the interference amount of ambient noise and thresholds may be compared in ascending order of threshold (for example, in order of threshold #1 to threshold #4). When, for example, the interference amount of ambient noise and thresholds are compared in ascending order of threshold (for example, in order of threshold #1 to threshold #4), there is a possibility that the processing efficiency improves. When, for example, comparison between the interference amount of ambient noise and threshold #1 is performed in advance of comparison with thresholds #2 to #4 and it is determined that the interference amount of ambient noise is not greater than threshold #1, it may be determined that ambient noise information #2 to ambient noise information #4 are not generated without comparison with thresholds #2 to #4. For this reason, the process of comparison with thresholds #2 to #4 may be skipped, and, for example, notification information having the format shown in FIG. 9 may be generated.

With Variation 1 described above, the format of notification information is partially omitted according to a determined result based on comparison between ambient noise and thresholds, so the information content of notification information is reduced. By reducing the information content of notification information, the signal amount of a control signal for providing notification information is reduced, so the efficiency of use of frequency is improved.

<Variation 2>

In Variation 2, an example in which notification of information indicating the priority of ambient noise is provided will be described. The priority of ambient noise indicates the priority of a radio system that transmits or receives a signal that is a factor of ambient noise (hereinafter, described as “ambient noise system”). When, for example, the ambient noise system is given a higher priority than a radio system supported by base station 100, it is determined that the priority of ambient noise is high. When, for example, the ambient noise system is not given a higher priority than a radio system supported by base station 100, it is determined that the priority of ambient noise is low.

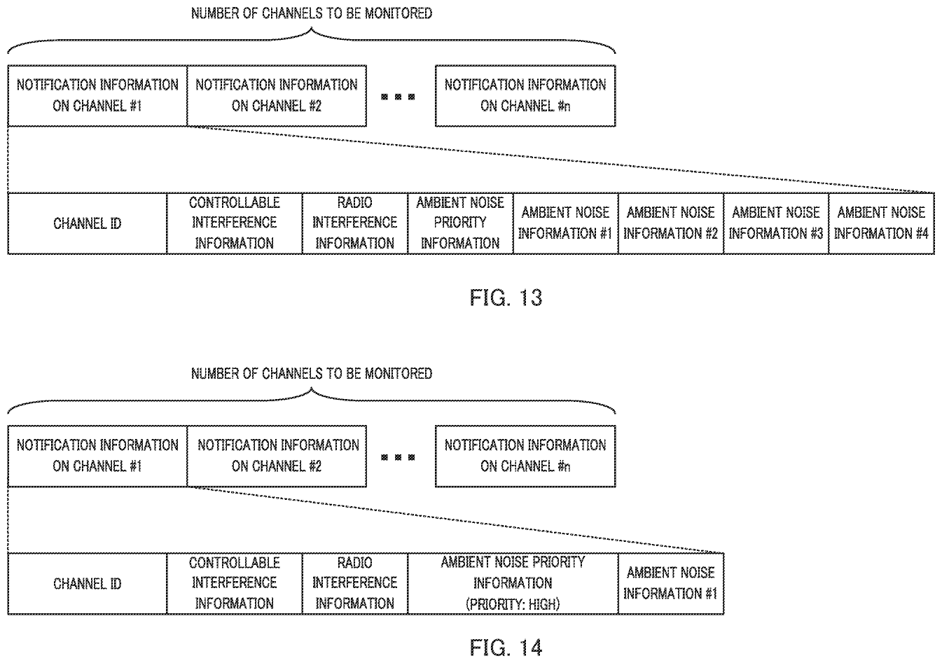

FIG. 13 is a view showing a third example of the format of notification information according to the present embodiment. In FIG. 13, the description of components similar to those of FIGS. 4 and 5 is omitted.

In the format shown in FIG. 13, an “ambient noise priority information” field is added to the “notification information on channel #k” field in the format shown in FIG. 5.

Information on the priority of ambient noise is set in the “ambient noise priority information” field. For example, in the “ambient noise priority information” field having a size of one bit, “1” is set when the priority of ambient noise is high, and “0” is set when the priority of ambient noise is low.

Information on the priority of ambient noise is not limited to two patterns, that is, the priority of ambient noise is high or the priority of ambient noise is low, and may indicate any one of three or more patterns of priority. In this case, the “ambient noise priority information” field may have at least a size of the number of bits corresponding to the number of patterns of priority. When, for example, the priority indicates any one of four patterns, the “ambient noise priority information” field may have at least a size of two bits. In this case, four logical patterns (0, 0), (0, 1), (1, 0), and (1, 1) using two bits may be associated with four patterns of priority.

The “ambient noise priority information” field is added in the format shown in FIG. 13, so notification of the priority of ambient noise is explicitly provided. The present disclosure is not limited thereto.

For example, notification of the priority of ambient noise may be implicitly provided. For example, notification of the priority of ambient noise may be implicitly provided by setting information indicating that the ambient noise level is level 4, in other words, communication is not possible, in the “ambient noise information” field. Even when notification of the priority of ambient noise is provided by this implicit notification, an increase in the information content of notification information is avoided. With this notification, the case where a detected ambient noise level is actually level 4 and the case where the priority of ambient noise is high are not distinguished from each other. However, each case indicates that the channel is not assigned to a terminal, so the cases do not need to be distinguished from each other.

When the priority of ambient noise is used for purposes other than determination as to whether the channel is not assigned to a terminal, ambient noise priority information needs to be provided. For example, in a large-scale event or the like, a case where a jamming radio wave is intentionally transmitted is conceivable. It is also possible to use ambient noise priority information in analysis or the like in such a case. When, for example, notification that the ambient noise level is relatively high (for example, level 4 or communication is not possible) is provided by the “ambient noise information” field and notification that the priority of ambient noise is low is provided by the “ambient noise priority information, the ambient noise may be analyzed as corresponding to a high-level radio wave, for example, a jamming radio wave, from an unexpected system (apparatus) low in priority.

When notification of the priority of ambient noise is explicitly provided in the format shown in FIG. 13, the “ambient noise information” field may be omitted.

FIG. 14 is a view showing a modification of the format of notification information, shown in FIG. 13. In the format shown in FIG. 14, the description of fields similar to those of the formats respectively shown in FIGS. 4, 5, and 13 is omitted.

The format of FIG. 14 is an example of the format in the case where information indicating that the priority of ambient noise is high is set in the “ambient noise priority information” field. In the format of FIG. 14, the “ambient noise information #2” field to the “ambient noise information #4” field are omitted as compared to the format of FIG. 13.

When it is determined that the priority of ambient noise is high, a terminal of NW #1 to which base station 100 belongs is not assigned to the channel. In this case, notification of an ambient noise level that indicates a compared result between the interference amount of ambient noise and a plurality of thresholds does not need to be provided. For this reason, as shown in FIG. 14, the “ambient noise information #2” field to the “ambient noise information #4” field may be omitted.

On the other hand, even when it is determined that the priority of ambient noise is high but when the ambient noise level is low (for example, level 0), a terminal of NW #1 to which base station 100 belongs may be assigned to the channel. For this reason, the “ambient noise information #1” field is not omitted in FIG. 14.

A determination method for the priority of ambient noise is not limited. For example, base station 100 (for example, interference classification processor 103 or notification information controller 108) may determine the priority of ambient noise by using the following method.

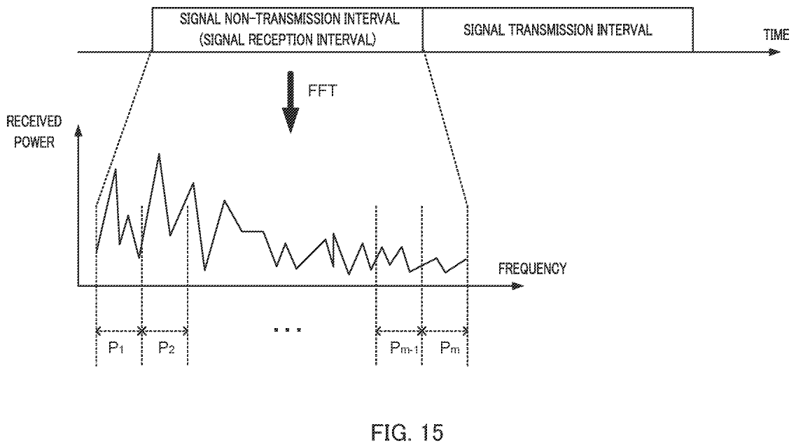

FIG. 15 is a view showing an example of determination as to the priority of ambient noise.

FIG. 15 shows a signal transmission interval and a signal non-transmission interval of base station 100, set in a time axis direction. An example of a result of time-frequency transform, such as fast Fourier transform (FFT), on a signal non-transmission interval is shown. In the result of time-frequency transform, the abscissa axis represents frequency, and the ordinate axis represents received power of each frequency component. A signal non-transmission interval may correspond to a signal reception interval and/or a radio interference monitoring interval.

For example, base station 100 estimates a frequency band used in signal transmission in a signal non-transmission interval in accordance with a result of time-frequency transform.

For example, base station 100 divides a result of time-frequency transform into m processing units P₁ to Pₘ in a frequency axis direction. Base station 100 determines a maximum and a minimum of received power for each divided processing unit.

Base station 100 compares the maximum and minimum of received power in each processing unit to determine whether the processing unit is used for signal transmission.

When, for example, the relationship α×max(Pⱼ)>min(Pⱼ) holds between maximum max(Pⱼ) and minimum min(Pⱼ) of received power in processing unit Pⱼ (j is an integer greater than or equal to one and less than or equal to m), base station 100 determines that processing unit Pⱼ is a frequency band used for signal transmission. α is a weighting coefficient concerned with determination. For example, α is a coefficient greater than zero.

Base station 100 determines a frequency band used for signal transmission by determining whether a processing unit is used for signal transmission for each of processing units P₁ to Pₘ, and determines a radio system (ambient noise system) associated with the frequency band. Base station 100 determines the priority of the determined ambient noise system.

Base station 100 may preliminarily have information on the frequency band of another radio system that transmits a signal in a system band and information on the priority of the another radio system.

<Example of Flow According to Variation 2>

An example of the flow of an ambient noise information generating process in the case where Variation 2 in which the “ambient noise priority information” field is added to the format of notification information is applied will be described.

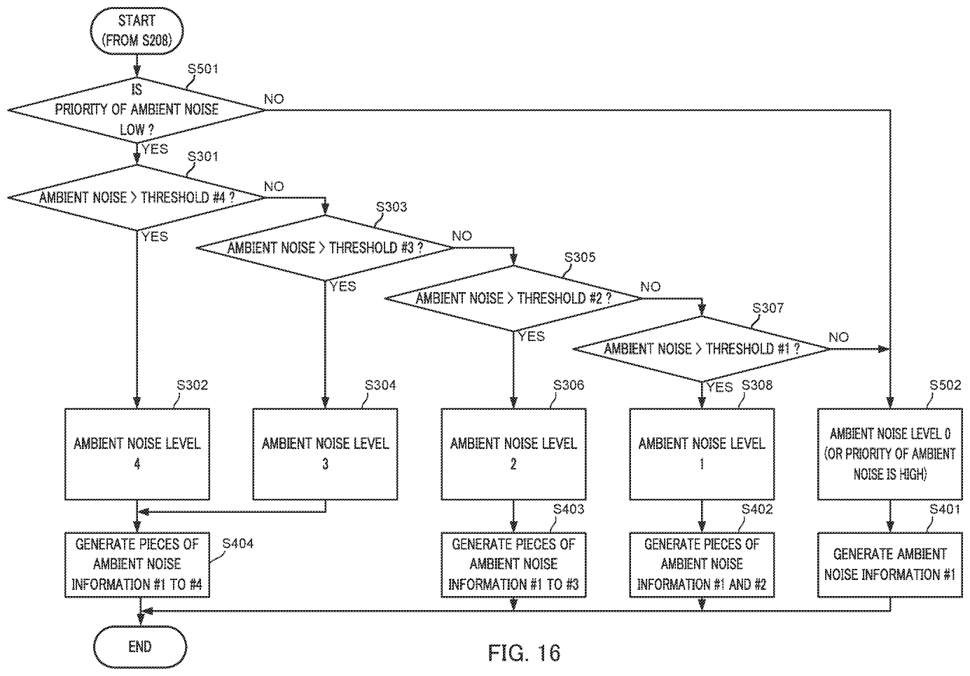

FIG. 16 is a flowchart showing a third example of a process to be executed in S209 of FIG. 7. Like step numbers are assigned to processes similar to those of FIGS. 8 and 12, and the description may be omitted.

The difference between FIG. 12 and FIG. 16 is that, in FIG. 16, the priority of ambient noise is determined in advance of S301.

Base station 100 determines whether the priority of ambient noise is low (S501).

When the priority of ambient noise is low (YES in S501), the flow proceeds to the process of S301. In this case, base station 100 generates ambient noise priority information indicating that the priority of ambient noise is low. The process from S301 has been described with reference to FIG. 8 or FIG. 12, so the description is omitted.

When the priority of ambient noise is not low (NO in S501), the flow proceeds to the process of S502. In this case, base station 100 generates ambient noise priority information indicating that the priority of ambient noise is high.

In S502, base station 100 determines that the ambient noise level in channel #k is level 0. The process of S502 is similar to the case where the interference amount of ambient noise is not greater than threshold #1 (NO in S307).

Base station 100 generates ambient noise information #1 (S401). In this case, base station 100 does not need to generate ambient noise information #2 to ambient noise information #4, the “ambient noise information #2” field to the “ambient noise information #4” field to set these pieces of information do not need to be included in the “notification information on channel k”.

The flow shown in FIG. 16 ends.

In Variation 2 described above, an example in which notification of information indicating the priority of ambient noise is provided has been described. With this notification, information on ambient noise is reduced, so the information content of notification information is reduced. With this notification, for example, channels are appropriately assigned to a terminal in a network, so it is possible to optimize the network (for example, both improvement in the efficiency of use of frequency and reduction of interference with another network and another system). With this notification, in assigning a channel to a terminal in a network, interference applied to a system having a high priority is avoided.

In Variation 2 described above, an example in which there are two patterns, that is, the state where “the priority of ambient noise is high” or the state where “the priority of ambient noise is low”, has been described. The present disclosure is not limited thereto. For example, there may be three patterns, that is, a state where “the priority of ambient noise is equivalent” may be provided in addition to the state where “the priority of ambient noise is high” or the state where “the priority of ambient noise is low”. The state where “the priority of ambient noise is equivalent” may mean, for example, a state where ambient noise corresponds to a signal of an ambient noise system having a priority equivalent to a radio system supported by base station 100. Here, when “the priority of ambient noise is high”, for example, transmission of a signal in the Wi-SUN terminal or the LoRa terminal may be controlled so as to avoid overlapping (or colliding) in a time domain with a signal corresponding to ambient noise. When “the priority of ambient noise is low”, for example, transmission of a signal in the Wi-SUN terminal or the LoRa terminal may be controlled so as to allow overlapping in a time domain with a signal corresponding to ambient noise. A transmission power of the Wi-SUN terminal or the LoRa terminal in the case where “the priority of ambient noise is low” may be controlled so as to be higher than a reference value. When “the priority of ambient noise is equivalent”, for example, transmission of a signal in the Wi-SUN terminal or the LoRa terminal may be controlled so as to allow overlapping in a time domain with a signal corresponding to ambient noise; however, a transmission power of the Wi-SUN terminal or the LoRa terminal is desirably controlled so as not to be higher than the reference value.

<Variation 3>

In the above-described embodiment and variations, the case where the “ambient noise information” field is included in the format of notification information and is provided at the same frequency as controllable interference information and radio interference information has been described. The present disclosure is not limited thereto. In Variation 3, an example in which notification of ambient noise information is provided at a frequency different from controllable interference information and/or radio interference information will be described.

For example, the notification frequency of ambient noise in the case where ambient noise is present in a steady state may be less than the notification frequency of ambient noise in the case where ambient noise is not present in a steady state. For example, the case where ambient noise is present in a steady state corresponds to the case where the interference amount of ambient noise in the monitoring result in a plurality of time intervals is greater than a predetermined value. For example, the case where ambient noise is not present in a steady state corresponds to the case where there are variations in which the interference amount of ambient noise in the monitoring result in a plurality of time intervals is greater than the predetermined value or less than or equal to the predetermined value.

When notification of ambient noise information is provided at a frequency different from controllable interference information and radio interference information, notification of information indicating the presence or absence of notification of ambient noise information may be provided.

Here, when the frequency (for example, period) at which notification of ambient noise information is provided is set to a fixed value (when, for example, an apparatus (for example, control apparatus) that receives notification information knows whether ambient noise information is included in notification information by setting a fixed value, notification of information indicating the presence or absence of ambient noise information does not need to be provided. On the other hand, when the frequency of notification of ambient noise is made variable (when, for example, by making the frequency variable, an apparatus that receives notification information does not identify whether ambient noise information is included in notification information), notification of information indicating the presence or absence of notification of ambient noise information is provided.

Information indicating the presence or absence of notification of ambient noise information may be replaced with a so-called higher layer message. When replaced with a higher layer message, a delay for providing notification of a higher layer message becomes greater than that of notification information, so the period at which the frequency of notification of ambient noise information is changed is set to be long such that a variance due to a delay of a higher layer message does not occur. When, for example, the frequency of notification of ambient noise information is changed at a short period, notification of information indicating the presence or absence of notification of ambient noise information is provided. A case where information indicating the presence or absence of notification of ambient noise information is included in notification information and a case where notification of the information is provided by using a higher layer message may be switched according to the presence or absence of a change and/or the length of the period of a change in frequency at which notification of ambient noise information is provided.

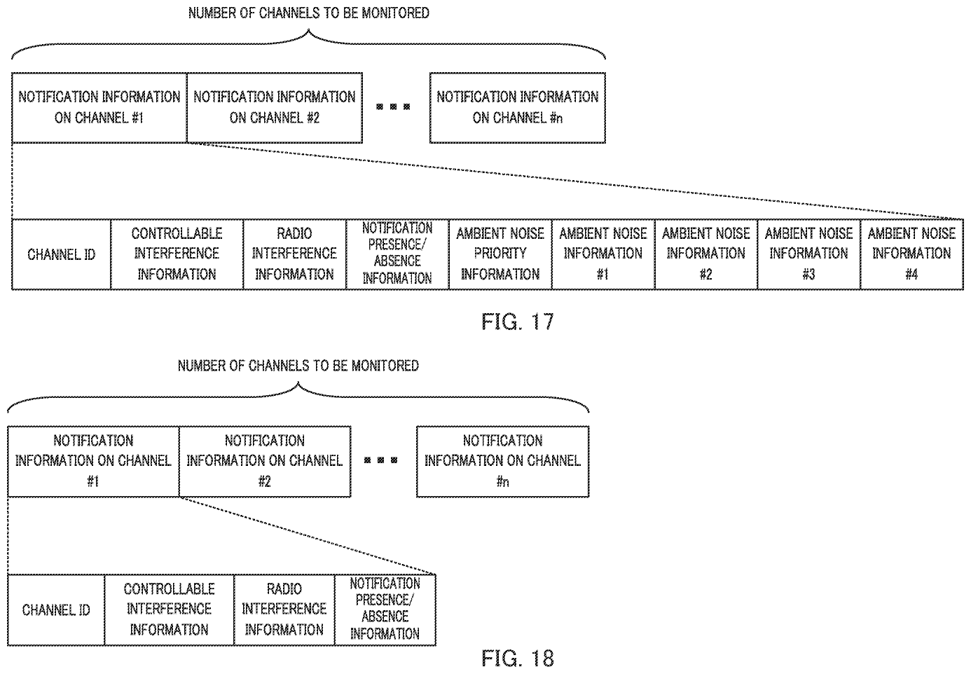

FIG. 17 is a view showing a fourth example of the format of notification information according to the present embodiment. FIG. 18 is a view showing a modification of the format of notification information, shown in FIG. 17. In the formats respectively shown in FIGS. 17 and 18, the description of fields similar to those of the formats respectively shown in FIGS. 4, 5, and 13 is omitted.

In the format shown in FIG. 17, a “notification presence/absence information” field is added to the “notification information on channel #k” field in the format shown in FIG. 13.

For example, information indicating the presence or absence of notification of ambient noise information is set in the “notification presence/absence information” field. For example, in the “notification presence/absence information” field having a size of one bit, “1” is set when notification of ambient noise information is provided, and “0” is set when notification of ambient noise information is not provided.

FIG. 17 is an example of the format in the case where notification of ambient noise information is provided in notification information on channel #1. For this reason, information indicating to provide notification of ambient noise information is set in the “notification presence/absence information” field. To provide notification of ambient noise priority information, the “ambient noise priority information” field and the “ambient noise information #1” field to the “ambient noise information #4” field are included in the format shown in FIG. 17.

FIG. 18 is an example of the format in the case where notification of ambient noise information is not provided in notification information on channel #1. For this reason, information indicating not to provide notification of ambient noise information is set in the “notification presence/absence information” field. In order not to provide notification of ambient noise information, the “ambient noise priority information” field, the “ambient noise information #1” field to the “ambient noise information #4” field, and the like are not included in the format shown in FIG. 18.

In the formats respectively shown in FIGS. 17 and 18, notification information on channel #1 has been described as an example. The presence or absence of notification of ambient noise information may be individually set in each channel.

<Example of Flow According to Variation 3>

An example of the flow of a process in the case where Variation 3 in which the “notification presence/absence information” field is added to the format of notification information is applied will be described.

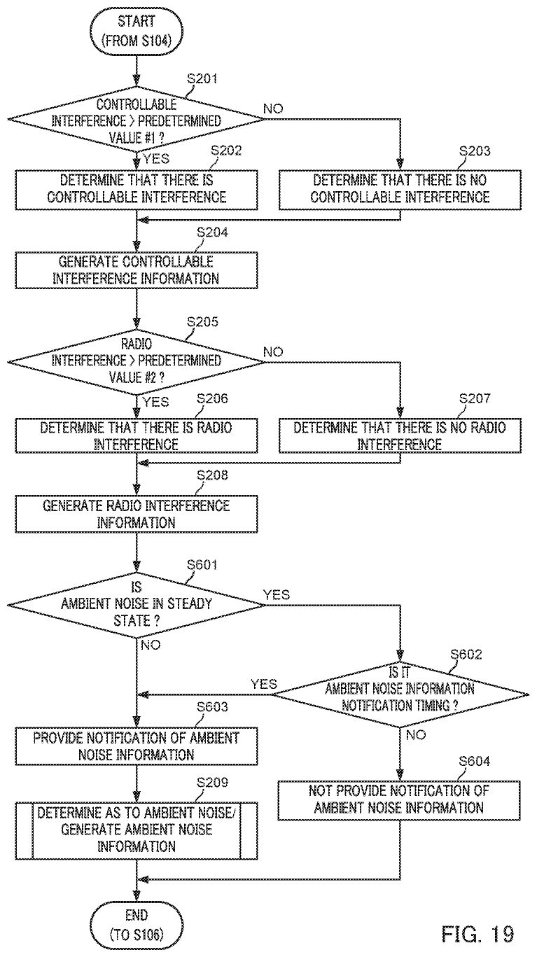

FIG. 19 is a flowchart showing a second example of a process to be executed in S105 of FIG. 6. In FIG. 19, like step numbers are assigned to processes similar to those of FIG. 7, and the description may be omitted.

In S208, controllable interference information is generated in accordance with the determined result of S206 or S207, and then base station 100 determines whether ambient noise is present in a steady state (S601).

When ambient noise is present in a steady state (YES in S601), base station 100 determines whether it is the timing to provide notification of ambient noise information (S602). The timing to provide notification of ambient noise information may be fixed in advance or may be set by control information included in a signal of a higher layer. For example, a period that defines the timing to provide notification of ambient noise information may be longer than a period that defines the timing to provide notification information.

When ambient noise is not present in a steady state (NO in S601) or when it is the timing to provide notification of ambient noise information (YES in S602), base station 100 determines to provide notification of ambient noise information (S603). In this case, for example, the example shown in FIG. 17 is used for the format of notification information, and base station 100 generates notification presence/absence information that indicates to provide notification of ambient noise information. The flow proceeds to S209.

When it is not the timing to provide notification of ambient noise information (NO in S602), base station 100 determines not to provide notification of ambient noise information (S604). In this case, for example, the example shown in FIG. 18 is used for the format of notification information, and notification presence/absence information that indicates not to provide notification of ambient noise information is generated. The flow shown in FIG. 19 ends.

A determined result of S601 may be different for each channel. The timing to provide notification of ambient noise information in S602 may be different for each channel or may be common among the channels.

In Variation 3 described above, an example in which notification of ambient noise information is provided at a frequency different from controllable interference information and/or radio interference information, for example, notification of ambient noise information is provided at a frequency lower than controllable interference information and/or radio interference information has been described. With this notification, information on ambient noise is reduced, so the information content of notification information is reduced. With the notification, for example, channels are appropriately assigned to a terminal in a network, so it is possible to optimize the network (for example, both improvement in the efficiency of use of frequency and reduction of interference with another network and another system).

In the format of notification information in each of the above-described examples, the information content of notification information may be reduced by omitting part of information or integrating part of information with statistical information. Hereinafter, another example of notification information will be described.

<Other Examples of Notification Information>

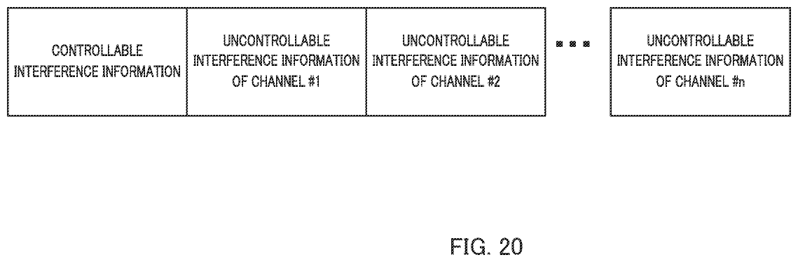

FIG. 20 is a view showing a fifth example of the format of notification information according to the present embodiment.

The format of notification information shown in FIG. 20 includes a “controllable interference information” field, and n “uncontrollable interference information” fields (an “uncontrollable interference information of channel #1” field to an “uncontrollable interference information of channel #n” field). n denotes the number of channels to be monitored. Channel #1 to channel #n show examples of channels that base station 100 is able to use (assign).

Information on controllable interference of usable channels (band), for example, information indicating a statistical amount (for example, a mean) of detection results of the interference amounts of controllable interference of usable channels, is set in the “controllable interference information” field. In other words, information set in the “controllable interference information” field indicates the statistical property of controllable interference in usable channels.

For example, a mean calculated by adding the interference amounts of controllable interference respectively in the channels #1 to #n and then dividing the added value by n may be set in the “controllable interference information” field.

For example, a mean calculated from information indicating the presence or absence of controllable interference in each of channels #1 to #n is set in the “controllable interference information” field. Information indicating the presence or absence of controllable interference, for example, indicates that there is controllable interference when a detected interference amount of controllable interference is greater than a predetermined value and indicates that there is no controllable interference when a detected interference amount of controllable interference is less than or equal to the predetermined value. For example, “1” indicates the case where there is controllable interference, “0” indicates the case where there is no controllable interference, and “1” or “0” for the n channels are added according to the presence or absence of controllable interference in each of channels #1 to #n. A mean calculated by dividing the added value by n may be set in the “controllable interference information” field.

A mean obtained in accordance with the above-described example may be compared with a plurality of thresholds, the mean may be associated with any one of a plurality of levels, and a value indicating the associated level may be set in the “controllable interference information” field.

In other words, a mean of detected interference amounts of controllable interference of channels may be set in the “controllable interference information” field, or the detected interference amounts of controllable interference of channels may be subjected to hard determination by using a threshold, and a mean of the results of hard determination may be set in the “controllable interference information” field. Alternatively, a mean of detected interference amounts of controllable interference of channels may be subjected to hard determination by using a threshold, and the result of hard determination may be set in the “controllable interference information” field.

A value indicating a statistical amount of detection results of the interference amounts of controllable interference of usable channels is not limited to the above-described example. For example, a value indicating a statistical amount is not limited to a mean and may be a maximum, a minimum, a median, or an integrated value of the interference amounts of controllable interference of channel #1 to channel #n. Alternatively, a value indicating a statistical amount may be a standard deviation, a variance, or the like of the interference amounts of controllable interference of channel #1 to channel #n. Alternatively, a value indicating a statistical amount may be a combination of two or more of the above-described examples of the values.

Information on uncontrollable interference of channel #k, for example, a detection result of the interference amount of uncontrollable interference in channel #k, is set in the “uncontrollable interference information of channel #k (k is an integer that is any one of one to n)” field. For example, information indicating the presence or absence of uncontrollable interference in channel #k is set in the “uncontrollable interference information of channel #k” field. Information indicating the presence or absence of uncontrollable interference, for example, indicates that there is uncontrollable interference when a detected interference amount of uncontrollable interference is greater than a predetermined value and indicates that there is no uncontrollable interference when a detected interference amount of uncontrollable interference is less than or equal to the predetermined value. For example, in the “uncontrollable interference information of channel #k” field having a size of one bit, “1” is set when there is uncontrollable interference in channel #k, and “0” is set when there is no uncontrollable interference in channel #k.

In the format of notification information, shown in FIG. 20, interference is classified, and information on the classified interference is set separately. In the format of notification information, shown in FIG. 20, notification of information on uncontrollable interference is provided for each channel, and notification of information on controllable interference is provided in units of a plurality of channels.

For example, base station 100 provides notification of information on classified interference by using the format shown in FIG. 20.

In FIG. 20, information indicating a channel associated with the “uncontrollable interference information” field and information for identifying the boundary between fields in notification information may be added.

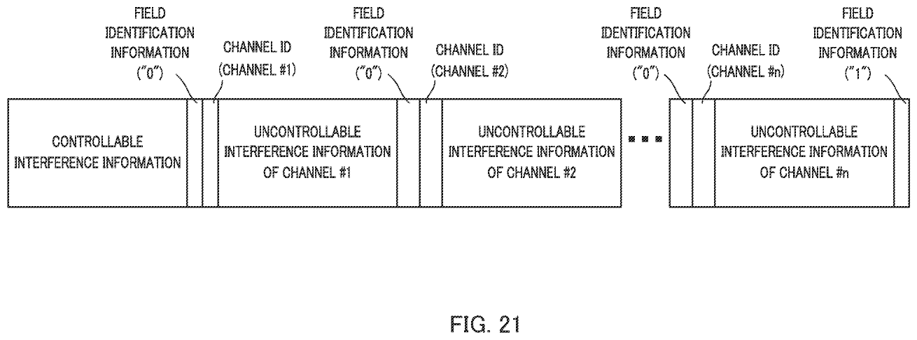

FIG. 21 is a view showing a sixth example of the format of notification information according to the present embodiment. In the format shown in FIG. 21, the description of fields similar to those of the format shown in FIG. 20 is omitted.

In the format of FIG. 21, a “channel ID” field and a “field identification information” field are added to the format of FIG. 20.

An identifier (for example, channel number) for identifying a channel is set in the “channel ID” field. For example, the identifier of channel #1 is set in the “channel ID (channel #1)” field added to the “uncontrollable interference information of channel #1” field.

A “field identification information” field is, for example, provided before a “channel ID” field and at the end of a notification information format. Information indicating whether a notification information field follows after is, for example, set in the “field identification information” field. For example, when a notification information field follows after, “0” is set in the “field identification information” field having a size of one bit, and, when a notification information field does not follow after, “1” is set in the “field identification information” field having a size of one bit. In the example of FIG. 21, “0” is set in the “field identification information” field provided before the “channel ID” field, and “1” is set in the “field identification information” field provided at the end of the notification information format.

In the format of notification information, at least one of the “channel ID” field and the “field identification information” field may be omitted. The formats of notification information, illustrated hereinafter, may include the “channel ID” field and the “field identification information” field, shown in FIG. 21.

In FIGS. 20 and 21 described above, examples of the format of notification information including one “controllable interference information” field in which information indicating a statistical amount of controllable interference of all the usable channels is set. The present disclosure is not limited thereto. Hereinafter, an example in which a plurality of groups (channel groups (hereinafter, described as CGs)) is set for usable channels and a plurality of “controllable interference information” fields corresponding to the number of CGs is included in the format of notification information will be described.

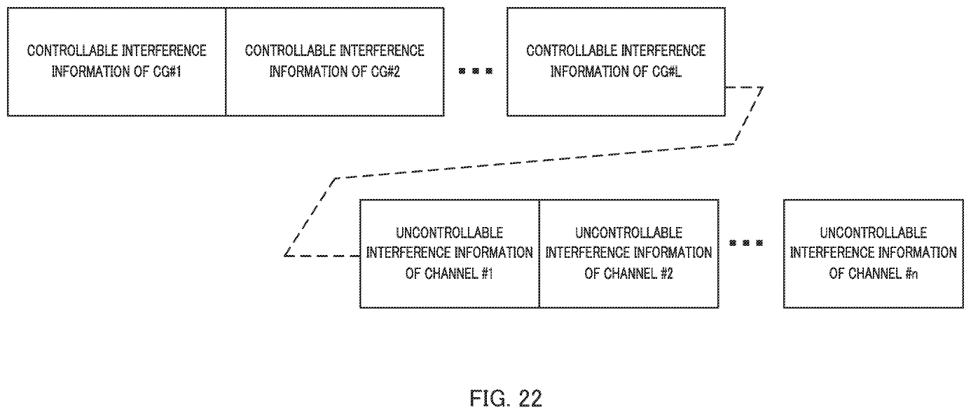

FIG. 22 is a view showing a seventh example of the format of notification information according to the present embodiment. In the format shown in FIG. 22, the description of fields similar to those of the format shown in FIG. 20 is omitted.

The difference between the format of FIG. 22 and the format of FIG. 20 is that, in the format of FIG. 22, L (L is an integer greater than or equal to one and less than or equal to n) “controllable interference information” fields (a “controllable interference information of CG #1” field to a “controllable interference information of CG #L” field) are provided. The example of the format of FIG. 22 is an example in which L CGs are set for n channels included in a usable band and to be monitored.

Information indicating a statistical amount of controllable interference of an associated CG is set in each of the L “controllable interference information” fields.

When, for example, channel #1 to channel #n are divided into two CGs, that is, CG #1 including channel #1 to channel #m (m is an integer greater than or equal to one and less than n) and CG #2 including channel #m+1 to channel #n, information indicating a statistical amount of the interference amounts of controllable interference of channel #1 to channel #m is set in the “controllable interference information of CG #1” field. Similarly, in this case, information indicating a statistical amount of the interference amounts of controllable interference of channel #m+1 to channel #n is set in the “controllable interference information of CG #2” field.

Channels included in each CG may be a plurality of channels successive in the frequency axis or may be a plurality of channels located discretely in the frequency axis. A channel common to two or more CGs may be included in each of the two or more CGs.

<Example of Flow of Generating Notification Information>

An example of a process flow in base station 100 to generate the above-described notification information in the format of FIG. 20 will be described.

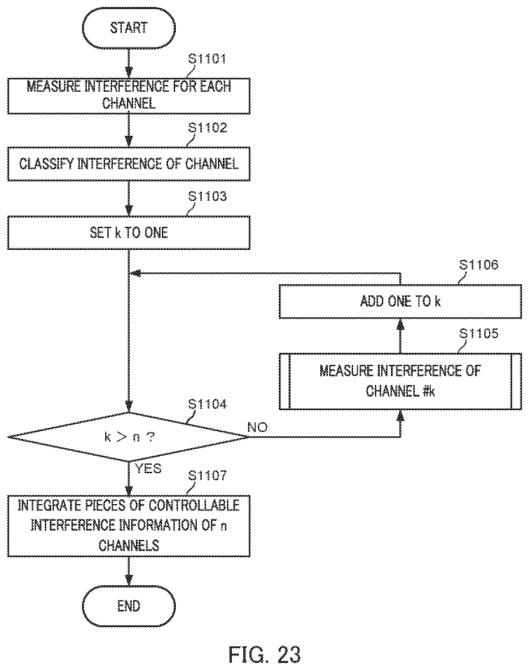

FIG. 23 is a flowchart showing a second example of a notification information generating process according to the present embodiment. For example, the flow shown in FIG. 23 is executed before the notification timing of notification information.

Base station 100 measures interference in each channel (S1101).

Base station 100 classifies the interference measured in each channel (S1102). Here, base station 100 classifies the interference measured in each channel into controllable interference and uncontrollable interference.

From S1103, a process on the classified interference is executed in each of the channels.

Base station 100 sets k to one (S1103). k is the index of a channel associated with the identification number of the channel.

Base station 100 determines whether k is greater than n (S1104). n denotes the number of channels included in a usable band and to be monitored. In other words, in S1104, it is determined whether a process on the classified interference is complete in all the channels to be monitored.

When k is not greater than n (NO in S1104), base station 100 determines interference of channel #k and executes a determination process on channel #k (S1105). The determination process in S1105 includes, for example, generation of controllable interference information of channel #k and generation of uncontrollable interference information of channel k. The determination process in S1105 will be described later.

Base station 100 adds one to k (S1106). The flow returns to the process of S1104.

When k is greater than n (YES in S1104), that is, when a process (determination process) on the classified interference is complete in all the channels to be monitored, base station 100 executes a process of integrating pieces of controllable interference information of the channels (S1107).

For example, base station 100 integrates pieces of controllable interference information of channels and generates pieces of controllable interference information of channel #1 to channel #n in accordance with the controllable interference information of channel #1 to the controllable interference information of channel #n. For example, base station 100 calculates a mean of controllable interference indicated by the controllable interference information of channel #1 to controllable interference indicated by the controllable interference information of channel #n and sets the calculated mean for controllable interference information.

When controllable interference indicated by the controllable interference information indicates the presence or absence of controllable interference based on a compared result with a predetermined value, base station 100 may add “1” when the number of channels in which there is controllable interference, add “0” when there is no controllable interference, and set a mean calculated by dividing the added result of “1” or “0” for the n channels by n for controllable interference information.

The flow shown in FIG. 23 ends.

<Example of Flow of Process in S1105>

Next, the flow of a process to be executed in S1105 of FIG. 23 will be described.

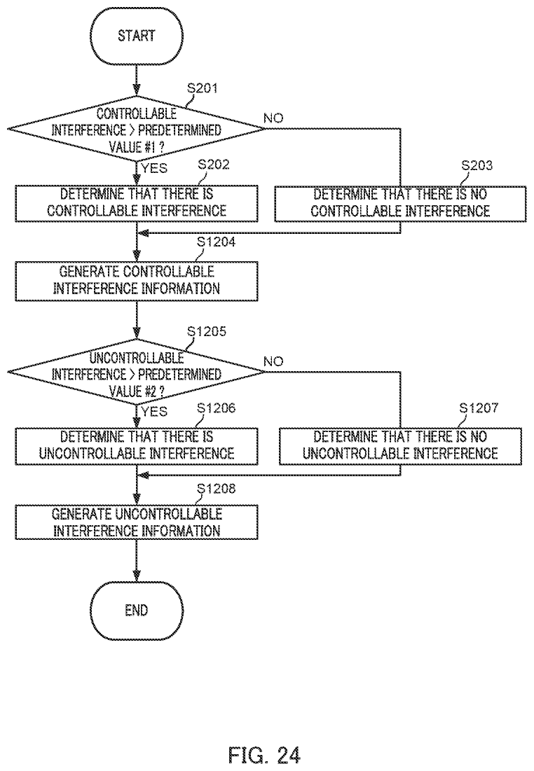

FIG. 24 is a flowchart showing a first example of a process to be executed in S1105 of FIG. 23. In FIG. 24, like step numbers are assigned to processes similar to those of FIG. 7, and the description may be omitted.

Base station 100 generates controllable interference information of each channel (for example, controllable interference information of channel #k) in accordance with the determined result of S202 or S203 (S1204). Controllable interference information of each channel is used in S1107 described above. Controllable interference information of each channel may indicate, for example, “1” or “0” according to the presence or absence of controllable interference in the channel. Alternatively, controllable interference information of each channel may indicate the interference amount of controllable interference when there is the controllable interference and may indicate “0” when there is no controllable interference.

Base station 100 determines whether the interference amount of uncontrollable interference is greater than predetermined value #2 (S1205).

When the interference amount of uncontrollable interference is greater than predetermined value #2 (YES in S1205), base station 100 determines that there is uncontrollable interference (S1206).

When the interference amount of uncontrollable interference is not greater than predetermined value #2 (NO in S1205), base station 100 determines that there is no uncontrollable interference (S1207).

Base station 100 generates uncontrollable interference information in accordance with the determined result of S1206 or S1207 (S1208). Uncontrollable interference information of each channel is generated in S1208.

When the process of S1208 is complete, determination of interference on channel #k is complete, and the flow of FIG. 24 ends. For example, in this case, the process proceeds to S1106 in the flow of FIG. 23.

In the above-described example, interference classification processor 103 in base station 100 that supports the LPWA system and that belongs to NW #1 classifies interference detected in each of a plurality of channels into controllable interference from a radio apparatus that supports the LPWA system and that belongs to NW #1 and interference different from controllable interference (uncontrollable interference). Notification information controller 108 outputs notification information including information on controllable interference and information on uncontrollable interference to the control apparatus of NW #1. In the notification information, the interference on controllable interference indicates a statistical amount of controllable interference in two or more channels among a plurality of channels.

With this configuration, interference can be classified, and notification of information on the classified interference can be separately provided, so notification of an interference detection result in a band used by various radio communication systems can be appropriately provided. With this notification, for example, channels are appropriately assigned to a terminal in a network, so it is possible to optimize the network (for example, both improvement in the efficiency of use of frequency and reduction of interference with another network and another system). In this notification, the information on controllable interference is able to provide notification of not controllable interference on each of a plurality of channels but a statistical property of a plurality of channels, so the information content of notification information is reduced.

<Variation 4>

In the following Variation 4, an example of the format of notification information in which controllable interference is classified in accordance with a communication mode and notification of information on the classified controllable interference of each communication mode is provided will be described.

Among pieces of controllable interference, controllable interference due to communication in the LoRa mode may be described as “controllable LoRa interference”. Among pieces of controllable interference, controllable interference due to communication in the Wi-SUN mode may be described as “controllable Wi-SUN interference”.

A process of classifying controllable interference into controllable LoRa interference and controllable Wi-SUN interference may be executed by, for example, interference classification processor 103 of base station 100. The classification method is not limited. For example, interference classification processor 103 may classify controllable interference in the case where the source of a received signal, determined through preamble detection, is a LoRa terminal to controllable LoRa interference and classifies controllable interference in the case where the source of a received signal, determined through preamble detection, is a Wi-SUN terminal to controllable Wi-SUN interference. Alternatively, controllable interference may be classified into controllable LoRa interference and controllable Wi-SUN interference by executing an inverse spread process over a received signal by using a spread signal of a LoRa signal and determining whether a spread process has been applied to the received signal. For example, controllable interference may be classified to controllable LoRa interference when a spread process has been applied to a received signal (when, for example, the difference in signal power between before and after an inverse spread process is greater than a predetermined value), and controllable interference may be classified to controllable Wi-SUN interference when a spread process has not been applied to a received signal (when, for example, the difference in signal power between before and after an inverse spread process is less than the predetermined value). For example, a inverse spread process may be executed by demodulator/decoder 102 of base station 100.

For channels for which the communication mode of an assignable terminal is defined, controllable interference of each channel may be classified in accordance with the assignable terminal. For example, controllable interference in the case where usable channels are channels to be specifically assigned to a LoRa terminal may be classified to controllable LoRa interference, and controllable interference in the case where usable channels are channels to be specifically assigned to a Wi-SUN terminal may be classified to controllable Wi-SUN interference.

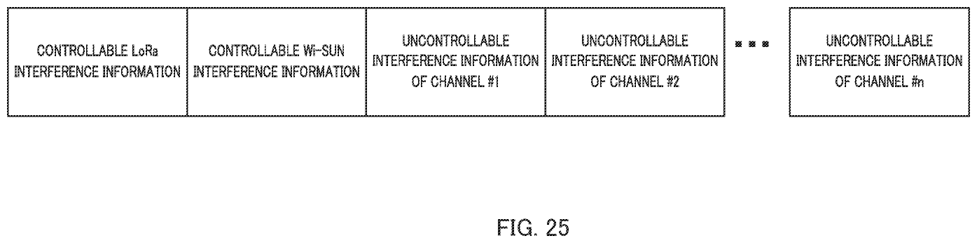

FIG. 25 is a view showing an eighth example of the format of notification information according to the present embodiment. In the format shown in FIG. 25, the description of fields similar to those of the format shown in FIG. 20 is omitted.

The difference between the format of FIG. 25 and the format of FIG. 20 is that the “controllable interference information” field in the format of FIG. 20 is replaced with a “controllable LoRa interference information” field and a “controllable Wi-SUN interference information” field in the format of FIG. 25.

Information on controllable LoRa interference in usable channels, for example, information indicating a statistical amount (for example, a mean) of detection results of the interference amounts of controllable LoRa interference in usable channels, is set in the “controllable LoRa interference information” field.

Information on controllable Wi-SUN interference in usable channels, for example, information indicating a statistical amount (for example, a mean) of detection results of the interference amounts of controllable Wi-SUN interference in usable channels, is set in the “controllable Wi-SUN interference information” field.

With the format shown in FIG. 25, notification of detection results of the interference amounts can be provided for each communication mode, so channels are appropriately assigned to a terminal in a network. Therefore, it is possible to optimize the network (for example, both improvement in the efficiency of use of frequency and reduction of interference with another network and another system).

When, for example, among usable channels, usable channels vary among communication modes, both optimization of a network and reduction in the information content of notification information are achieved by using the format shown in FIG. 25.

An example in which notification of detection results of the interference amounts is provided for each communication mode is not limited to the example of FIG. 25. Hereinafter, an example of the format of notification information in the case where usable channels are divided into a group of channels specifically assigned to a LoRa terminal, a group of channels specifically assigned to a Wi-SUN terminal, and a group of shared channels that may be assigned to both a LoRa terminal and a Wi-SUN terminal will be described.

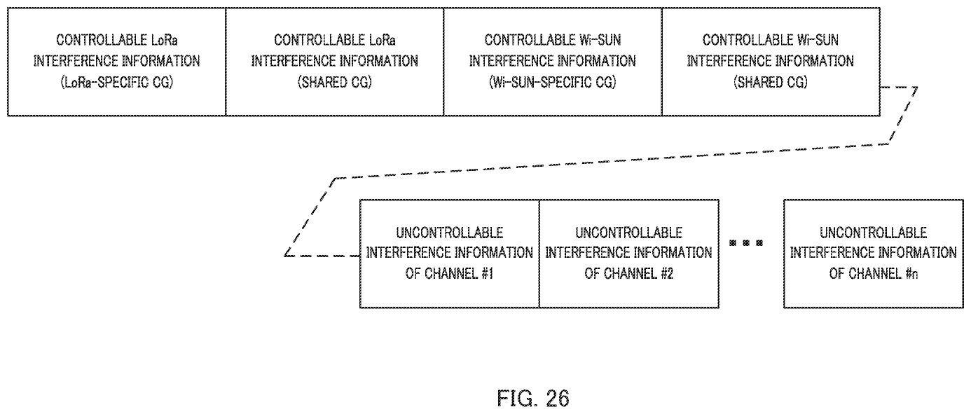

FIG. 26 is a view showing a ninth example of the format of notification information according to the present embodiment. In the format shown in FIG. 26, the description of fields similar to those of the formats respectively shown in FIGS. 20 and 25 is omitted.

The “controllable LoRa interference information” field in the format of FIG. 25 is replaced with a “controllable LoRa interference information” field of a LoRa-specific CG and a “controllable LoRa interference information” of a shared CG in the format of FIG. 26. The “controllable Wi-SUN interference information” field in the format of FIG. 25 is replaced with a “controllable Wi-SUN interference information” field of a Wi-SUN-specific CG and a “controllable Wi-SUN interference information” of a shared CG in the format of FIG. 26.

Information on controllable LoRa interference in channels specifically assigned to a LoRa terminal among usable channels is set in the “controllable LoRa interference information” field of the LoRa-specific CG. Information on controllable LoRa interference in shared channels among usable channels is set in the “controllable LoRa interference information” field of the shared CG.

Information on controllable Wi-SUN interference in channels specifically assigned to a Wi-SUN interference terminal among usable channels is set in the “controllable Wi-SUN interference information” field of the Wi-SUN-specific CG. Information on controllable Wi-SUN interference in shared channels among usable channels is set in the “controllable Wi-SUN interference information” field of the shared CG.

In this case, controllable interference in shared channels includes both controllable LoRa interference and controllable Wi-SUN interference, so notification of controllable LoRa interference and notification of controllable Wi-SUN interference are separately provided for one group of shared channels.

With the format shown in FIG. 26, notification of detection results of the interference amounts can be provided for each communication mode and each type of channel (specific channel or shared channel), so channels are appropriately assigned to a terminal in a network. Therefore, it is possible to optimize the network (for example, both improvement in the efficiency of use of frequency and reduction of interference with another network and another system).

When, for example, among usable channels, usable channels vary among communication modes, both optimization of a network and reduction in the information content of notification information are achieved by using the format shown in FIG. 26.

<Example of Flow According to Variation 4>

An example of a process flow in base station 100 to generate the above-described notification information in the format of FIG. 25 will be described.

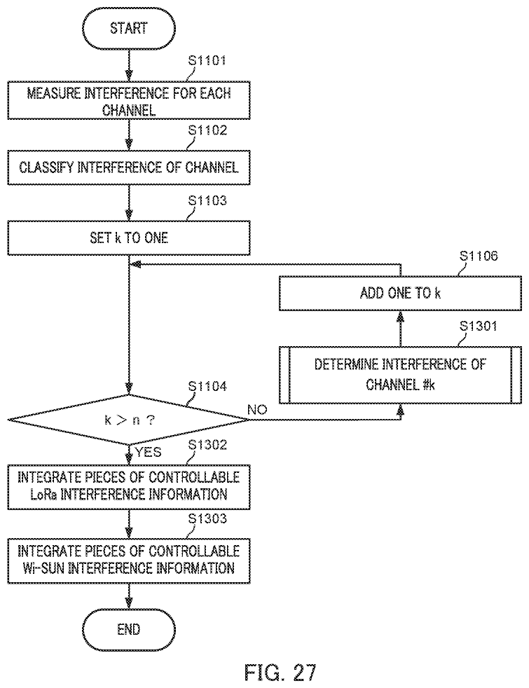

FIG. 27 is a flowchart showing a third example of a notification information generating process according to the present embodiment. In FIG. 27, like step numbers are assigned to processes similar to those of FIG. 23, and the description may be omitted.

In the flow of FIG. 27, the process of S1105 in FIG. 23 is replaced with the process of S1301, and the process of S1107 in FIG. 23 is replaced with the process of S1302 and the process of S1303.

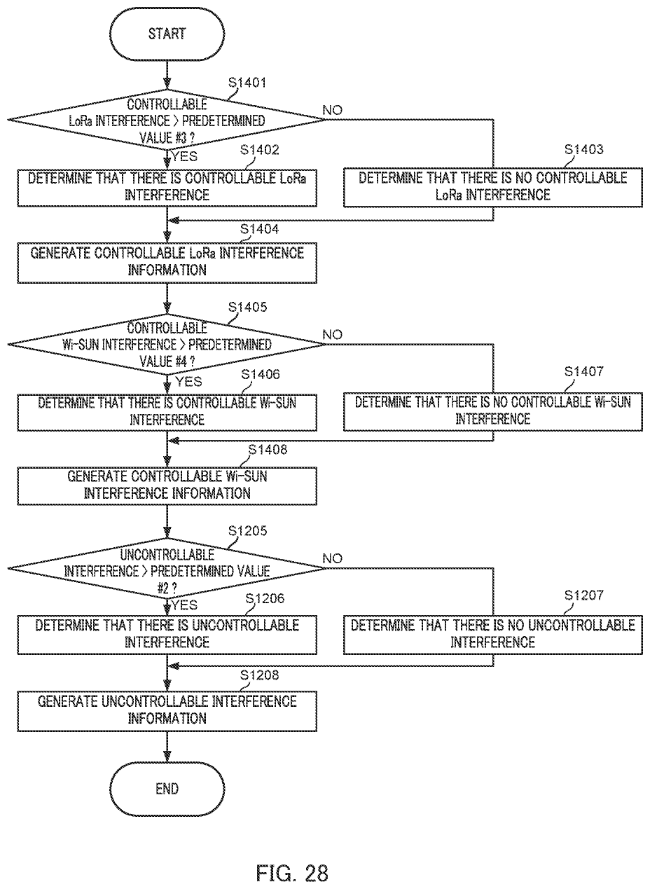

When k is not greater than n (NO in S1104), base station 100 determines interference of channel #k and executes a determination process on channel #k (S1301). The determination process in S1301 includes, for example, generation of controllable LoRa interference information of channel #k, generation of controllable Wi-SUN interference information of channel #k, and generation of uncontrollable interference information of channel #k. The process of S1301 will be described later with reference to FIG. 28.

When k is greater than n (YES in S1104), base station 100 executes a process of integrating pieces of controllable LoRa interference information of the channels (S1302). For example, base station 100 integrates pieces of controllable LoRa interference information of the channels and generates controllable LoRa interference information of channel #1 to channel #n in accordance with the controllable LoRa interference information of channel #1 to the controllable LoRa interference information of channel #n.

Base station 100 executes a process of integrating pieces of controllable Wi-SUN interference information (S1303). For example, base station 100 integrates pieces of controllable Wi-SUN interference information of the channels and generates controllable Wi-SUN interference information of channel #1 to channel #n in accordance with the controllable Wi-SUN interference information of channel #1 to the controllable Wi-SUN interference information of channel #n.

<Example of Flow of Process in S1301>

Next, the flow of a process to be executed in S1301 of FIG. 27 will be described.

FIG. 28 is a flowchart showing a first example of a process to be executed in S1301 of FIG. 27. In FIG. 28, like step numbers are assigned to processes similar to those of FIG. 24, and the description may be omitted.

In the flow of FIG. 28, the processes of S201 to S203, and S1204 in FIG. 24 are replaced with the processes of S1401 to S1408.

Base station 100 determines whether the interference amount of controllable LoRa interference is greater than predetermined value #3 (S1401).

When the interference amount of controllable LoRa interference is greater than predetermined value #3 (YES in S1401), base station 100 determines that there is controllable LoRa interference (S1402).

When the interference amount of controllable LoRa interference is not greater than predetermined value #3 (NO in S1401), base station 100 determines that there is no controllable LoRa interference (S1403).

Base station 100 generates controllable LoRa interference information of each channel (for example, controllable LoRa interference information of channel #k) in accordance with the determined result of S1402 or S1403 (S1404). Controllable LoRa interference information of each channel is used in S1302 described above. An example of a value indicated by controllable LoRa interference information of each channel is similar to a value indicated by controllable interference information of each channel, shown in FIG. 24, so the description is omitted.

Base station 100 determines whether the interference amount of controllable Wi-SUN interference is greater than predetermined value #4 (S1405).

When the interference amount of controllable Wi-SUN interference is greater than predetermined value #4 (YES in S1405), base station 100 determines that there is controllable Wi-SUN interference (S1406).

When the interference amount of controllable Wi-SUN interference is not greater than predetermined value #4 (NO in S1405), base station 100 determines that there is no controllable Wi-SUN interference (S1407).

Base station 100 generates controllable Wi-SUN interference information of each channel (for example, controllable Wi-SUN interference information of channel #k) in accordance with the determined result of S1406 or S1407 (S1408). Controllable Wi-SUN interference information of each channel is used in S1303 described above. An example of a value indicated by controllable Wi-SUN interference information of each channel is similar to a value indicated by controllable interference information of each channel, shown in FIG. 24, so the description is omitted.

With Variation 4 described above, notification of detection results of the interference amounts can be provided for each communication mode of a terminal, so channels are appropriately assigned to a terminal in a network. Therefore, it is possible to further optimize the network (for example, both improvement in the efficiency of use of frequency and reduction of interference with another network and another system). In this notification, the information on controllable interference is able to provide notification of not controllable interference on each of a plurality of channels but a statistical property of a plurality of channels, so the information content of notification information is reduced.

<Variation 5>

In the above-described example of the format of notification information, an example in which the “uncontrollable interference information” field is provided and notification of information on uncontrollable interference in each channel is provided has been described. The present disclosure is not limited thereto. For example, uncontrollable interference may be classified into radio interference and ambient noise, and the priority may be determined for ambient noise. In the following Variation 5, an example in which fields by which notification of information on radio interference in each channel and notification of information on ambient noise higher in priority among pieces of ambient noise are provided will be described.

A determination method for the priority of ambient noise is not limited. For example, base station 100 (for example, interference classification processor 103 or notification information controller 108) may determine the priority of ambient noise by using the following method. For example, the method described with reference to FIG. 15 may be applied as a determination method for the priority of ambient noise.

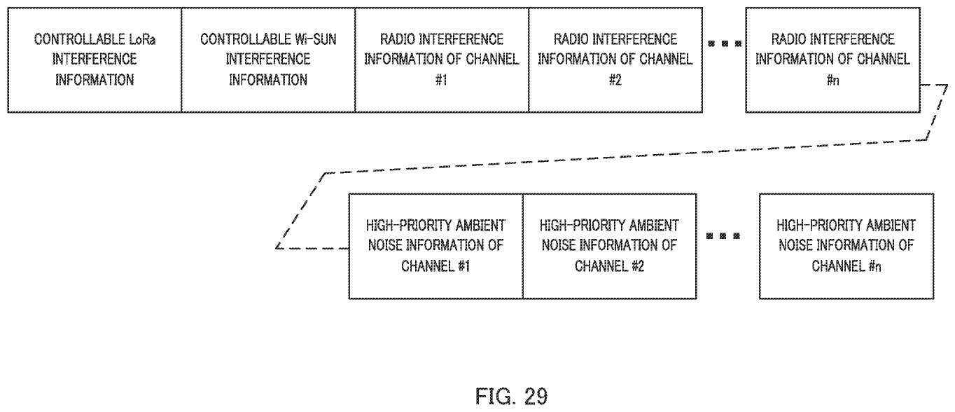

FIG. 29 is a view showing a tenth example of the format of notification information according to the present embodiment. In the format shown in FIG. 29, the description of fields similar to those of the formats respectively shown in FIGS. 20 and 25 is omitted.

The difference between the format of FIG. 29 and the format of FIG. 25 is that the “uncontrollable interference information” field of each channel in the format of FIG. 25 is replaced with a “radio interference information” field of each channel and a “high-priority ambient noise information” field of each channel in the format of FIG. 29.

Information on radio interference of channel #k, for example, a detection result of the interference amount of radio interference in channel #k, is set in the “radio interference information of channel #k” field. For example, information indicating the presence or absence of radio interference in channel #k is set in the “radio interference information of channel #k” field. Information indicating the presence or absence of radio interference, for example, indicates that there is radio interference when a detected interference amount of radio interference is greater than a predetermined value and indicates that there is no radio interference when a detected interference amount of radio interference is less than or equal to the predetermined value. For example, in the “radio interference information of channel #k” field having a size of one bit, “1” is set when there is radio interference in channel #k, and “0” is set when there is no radio interference in channel #k.

Information on ambient noise with a high priority (hereinafter, which may be described as “high-priority ambient noise”) among pieces of ambient noise in channel #k is set in the “high-priority ambient noise information of channel #k” field. For example, a detection result of the interference amount of high-priority ambient noise in channel #k is set in the “high-priority ambient noise information of channel #k” field. For example, information indicating the presence or absence of high-priority ambient noise in channel #k is set in the “high-priority ambient noise information of channel #k” field. Information indicating the presence or absence of high-priority ambient noise, for example, indicates that there is high-priority ambient noise when a detected interference amount of high-priority ambient noise is greater than a predetermined value and indicates that there is no high-priority ambient noise when a detected interference amount of high-priority ambient noise is less than or equal to the predetermined value. For example, in the “high-priority ambient noise information of channel #k” field having a size of one bit, “1” is set when there is high-priority ambient noise in channel #k, and “0” is set when there is no high-priority ambient noise in channel #k.

<Example of Flow According to Variation 5>

A process flow in base station 100 to generate the above-described notification information in the format of FIG. 29 will be described.

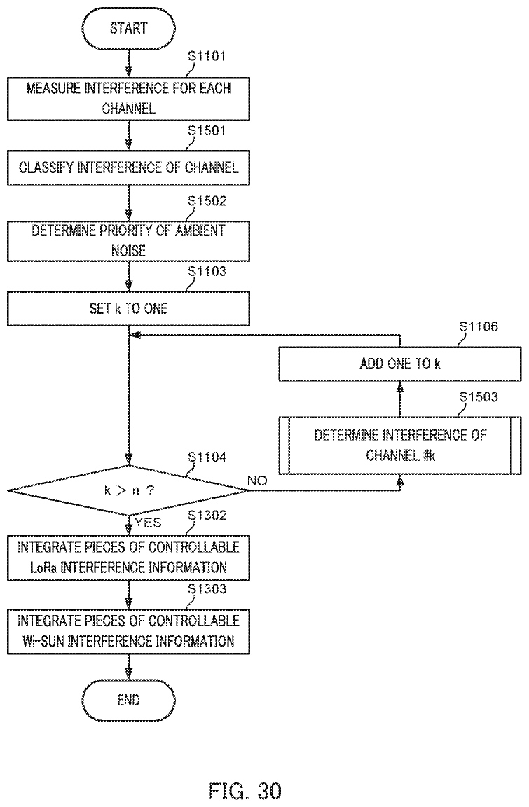

FIG. 30 is a flowchart showing a fourth example of a notification information generating process according to the present embodiment. In FIG. 30, like step numbers are assigned to processes similar to those of FIGS. 23 and 27, and the description may be omitted.

In the flow of FIG. 30, the process of S1502 is added to FIG. 27 before S1103. The processes of S1102 and S1301 in FIG. 27 are respectively replaced with the processes of S1501 and S1503.

Base station 100 classifies the interference measured in each channel (S1501). Here, base station 100 classifies the interference measured in each channel into controllable interference, radio interference, and ambient noise.

Base station 100 determines the priority of the classified ambient noise (S1502).

Base station 100 sets k to one (S1103). k is the index of a channel associated with the identification number of the channel.

Base station 100 determines whether k is greater than n (S1104).

When k is not greater than n (NO in S1104), base station 100 determines interference of channel #k and executes a determination process on channel #k (S1503). The determination process in S1503 includes, for example, generation of controllable interference information of channel #k, generation of radio interference information of channel #k, and generation of high-priority ambient noise information of channel #k. The determination process in S1503 will be described later.

<Example of Flow of Process in S1503>

Next, the flow of a process to be executed in S1503 of FIG. 30 will be described.

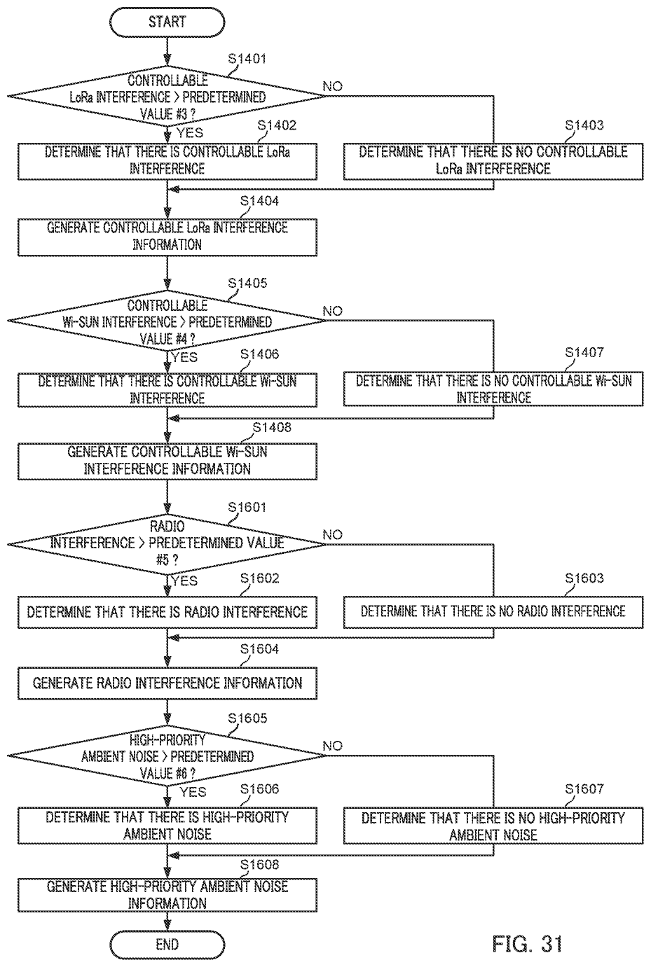

FIG. 31 is a flowchart showing a first example of a process to be executed in S1503 of FIG. 30. In FIG. 31, like step numbers are assigned to processes similar to those of FIGS. 24 and 28, and the description may be omitted.

In the flow of FIG. 31, the processes of S1205 to S1208 in FIG. 28 are replaced with the processes of S1601 to S1608.

Base station 100 determines whether the interference amount of radio interference is greater than predetermined value #5 (S1601).

When the interference amount of radio interference is greater than predetermined value #5 (YES in S1601), base station 100 determines that there is radio interference (S1602).

When the interference amount of radio interference is not greater than predetermined value #5 (NO in S1601), base station 100 determines that there is no radio interference (S1603).

Base station 100 generates radio interference information in accordance with the determined result of S1602 or S1603 (S1604). Radio interference information of each channel is generated in S1604.

Base station 100 determines whether the interference amount of high-priority ambient noise is greater than predetermined value #6 (S1605).

When the interference amount of high-priority ambient noise is greater than predetermined value #6 (YES in S1605), base station 100 determines that there is high-priority ambient noise (S1606).

When the interference amount of high-priority ambient noise is not greater than predetermined value #6 (NO in S1605), base station 100 determines that there is no high-priority ambient noise (S1607).

Base station 100 generates high-priority ambient noise information in accordance with the determined result of S1606 or S1607 (S1608). High-priority ambient noise information of each channel is generated in S1608.

When the process of S1608 is complete, determination of interference on channel #k is complete, and the flow of FIG. 31 ends. For example, in this case, the process proceeds to S1106 in the flow of FIG. 30.

In Variation 5 described above, uncontrollable interference is classified into radio interference and ambient noise, and it is determined whether the classified ambient noise includes high-priority ambient noise. Notification of information on radio interference and notification of information on high-priority ambient noise are separately provided. With this notification, notification of a detection result of the interference amount is appropriately provided by segments. With the notification, channels are appropriately assigned to a terminal in a network, so it is possible to optimize the network (for example, both improvement in the efficiency of use of frequency and reduction of interference with another network and another system).

<Variation 6>

In the format of notification information, shown in FIG. 29, an example in which the “radio interference information” field for providing notification of information on radio interference and the “high-priority ambient noise information” field for providing notification of information on high-priority ambient noise are separately provided has been described. The present disclosure is not limited thereto. In the following Variation 6, an example of the format of notification information in which a field for providing notification of information integrating information on radio interference and notification of information on high-priority ambient noise are provided will be described.

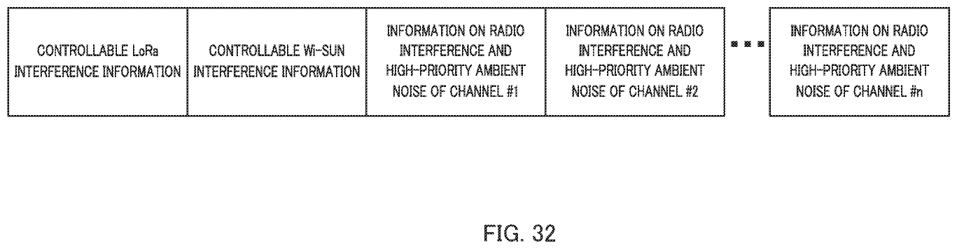

FIG. 32 is a view showing an eleventh example of the format of notification information according to the present embodiment. In the format shown in FIG. 32, the description of fields similar to those of the formats respectively shown in FIGS. 20, 25 and 29 is omitted.

The difference between the format of FIG. 32 and the format of FIG. 29 is that the “radio interference information” field and the “high-priority ambient noise information” field of each channel are replaced with an “information on radio interference and high-priority ambient noise” field of each channel.

Information on radio interference and high-priority ambient noise of channel #k, for example, information obtained from a detection result of the interference amount of radio interference in channel #k and a detection result of the interference amount of high-priority ambient noise in channel #k, is set in the “information on radio interference and high-priority ambient noise of channel #k” field. For example, information indicating a statistical amount (for example, a mean, an integrated value, or the like) between the interference amount of radio interference in channel #k and the interference amount of high-priority ambient noise in channel #k is set in the “information on radio interference and high-priority ambient noise of channel #k”.

<Example of Flow according to Variation 6>

A process flow in base station 100 in the case where notification information in the above-described format of FIG. 32 is generated is similar to that of FIG. 30 shown in Variation 5. When notification information in the format of FIG. 32 is generated, the process of S1503 of FIG. 30 is different from that of Variation 5. Hereinafter, the process in S1503 of FIG. 30 will be described.

<Example of Flow of Process in S1503>

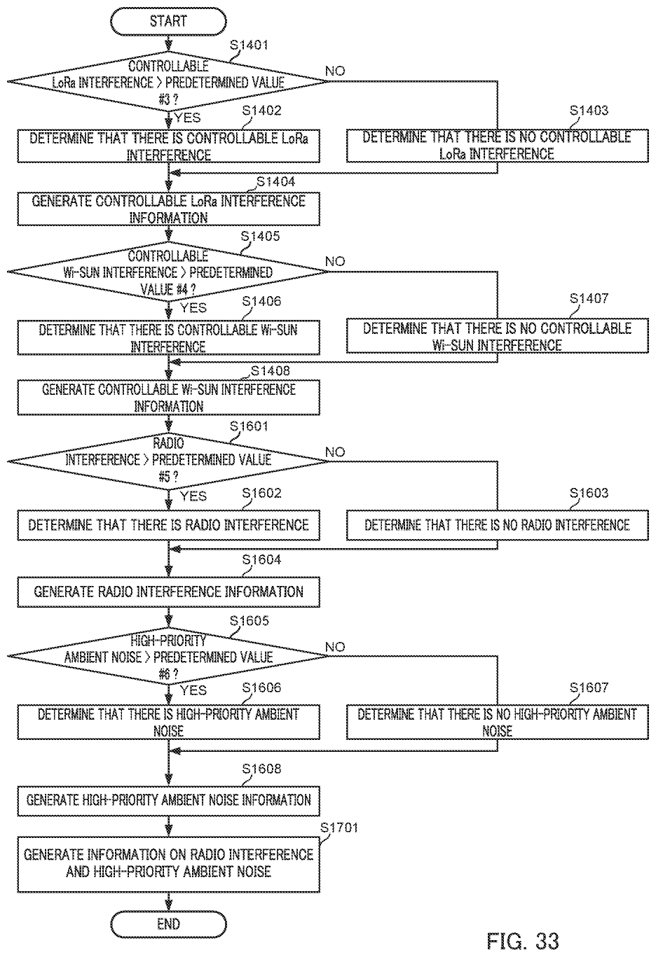

FIG. 33 is a flowchart showing a second example of a process to be executed in S1503 of FIG. 30. In FIG. 33, like step numbers are assigned to processes similar to those of FIGS. 24, 28, and 30, and the description may be omitted.

In the flow of FIG. 33, the process of S1701 is added after S1608 in FIG. 31.

Base station 100 generates information on radio interference and high-priority ambient noise of each channel (for example, information on radio interference and high-priority ambient noise of channel #k) in accordance with the radio interference information of each channel, generated in S1605, and the high-priority ambient noise information of each channel, generated in S1608 (S1701).

In Variation 6 described above, uncontrollable interference is classified into radio interference and ambient noise, and it is determined whether the classified ambient noise includes ambient noise with a high priority. Notification of information on radio interference and high-priority ambient noise, generated by integrating information on radio interference and information on high-priority ambient noise, is provided. With this notification, notification of a detection result of the interference amount is appropriately provided by segments. With this notification, channels are appropriately assigned to a terminal in a network, so it is possible to optimize the network (for example, both improvement in the efficiency of use of frequency and reduction of interference with another network and another system). With this notification, notification of information on radio interference and notification of information on high-priority ambient noise are not separately provided, so the information content of notification information is reduced.

<Variation 7>

In the following Variation 7, an example in which a frequency of notification is set for information to be provided for notification will be described. In this case, the format of notification information may be selected according to the set notification frequency. A difference in notification frequency may be regarded as a difference in notification timing.

An example of a selected format of notification information in the case where a notification frequency of controllable interference information and a notification frequency of uncontrollable interference information are set independently of each other in the format of notification information, shown in FIG. 25, will be described.

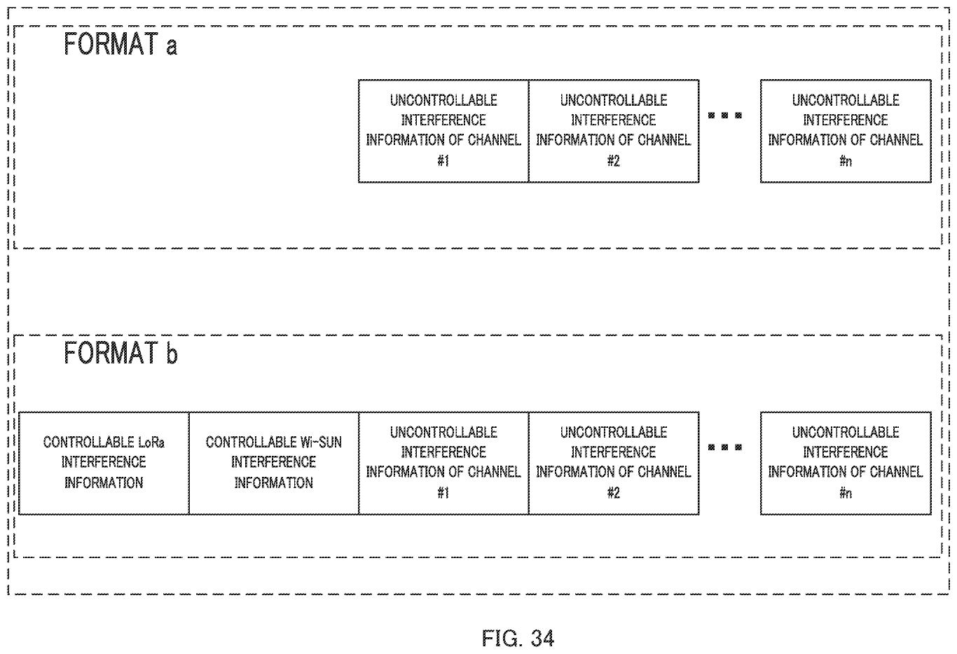

FIG. 34 is a view showing a first example of the formats of notification information at two different notification timings. In the formats shown in FIG. 34, the description of fields similar to those of the formats respectively shown in FIGS. 20 and 25 is omitted.

Format a of notification information of FIG. 34 is an example of the format of notification information at timing at which notification of uncontrollable interference information is provided and at timing at which notification of controllable interference information is not provided. Notification of controllable interference information is not provided in format a, so the “controllable interference information” field is omitted.

Format b of notification information of FIG. 34 is an example of the format of notification information at timing at which notification of uncontrollable interference information is provided and at timing at which notification of controllable interference information is provided. Notification of uncontrollable interference information and controllable interference information is provided in format b, so an “uncontrollable interference information” field and a “controllable interference information” field are provided.

When, for example, the notification frequency of controllable interference information is lower than the notification frequency of uncontrollable interference information, any one of format b including the “controllable interference information” field and the “uncontrollable interference information” field and format a including the “uncontrollable interference information” field and not including the “controllable interference information” field may be selected and set for the format of notification information.

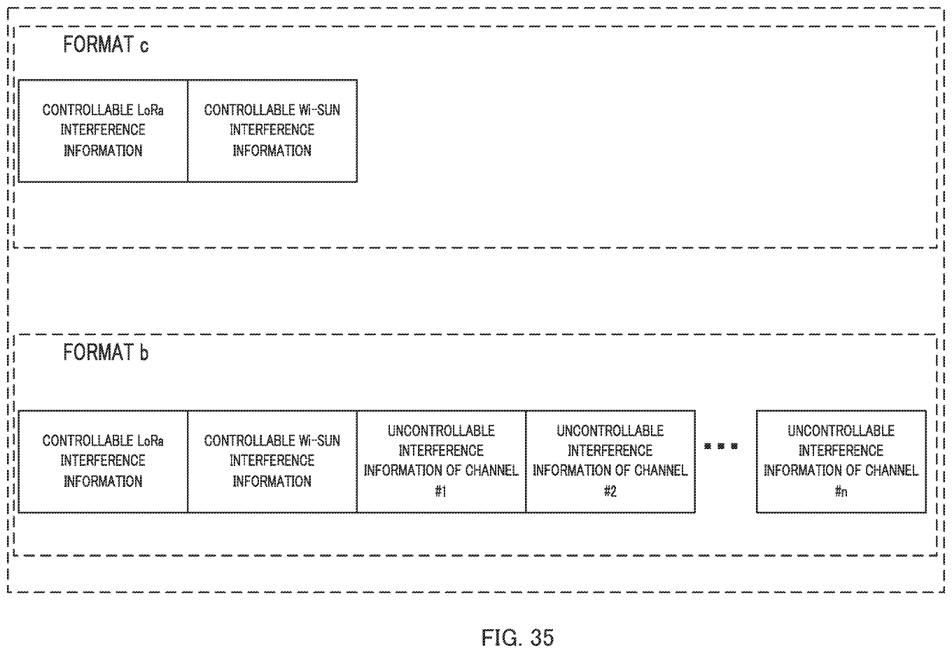

FIG. 35 is a view showing a second example of the formats of notification information at two different notification timings. In the formats shown in FIG. 35, the description of fields similar to those of the formats respectively shown in FIGS. 20 and 25 is omitted.

Format c of notification information of FIG. 35 is an example of the format of notification information at timing at which notification of controllable interference information is provided and at timing at which notification of uncontrollable interference information is not provided. Notification of uncontrollable interference information is not provided in format c, so the “uncontrollable interference information” field is omitted.

Format b of notification information of FIG. 35 is similar to format b of notification information of FIG. 34.

When, for example, the notification frequency of controllable interference information is higher than the notification frequency of uncontrollable interference information, any one of format b including the “controllable interference information” field and the “uncontrollable interference information” field and format c including the “controllable interference information” field and not including the “uncontrollable interference information” field may be selected and set for the format of notification information.

When the notification frequency of controllable interference information and the notification frequency of uncontrollable interference information are set independently of each other, any one of the three formats, that is, format a, format b, and format c shown in FIG. 34 and FIG. 35 may be selected and set for the format of notification information according to notification timing.

Next, an example in which the notification frequency of controllable interference information, the notification frequency of radio interference information, and the notification frequency of high-priority ambient noise are independently set in the format of notification information, shown in FIG. 29, will be described.

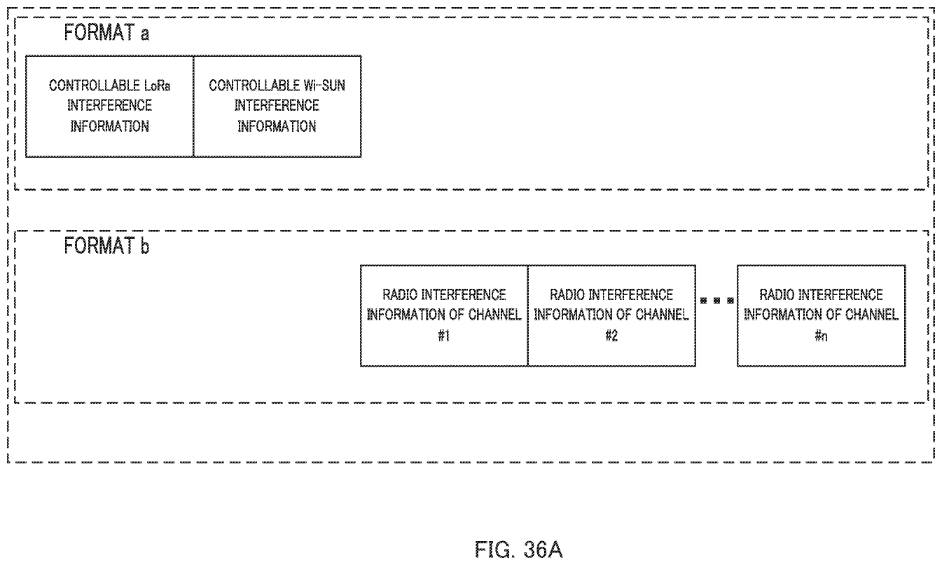

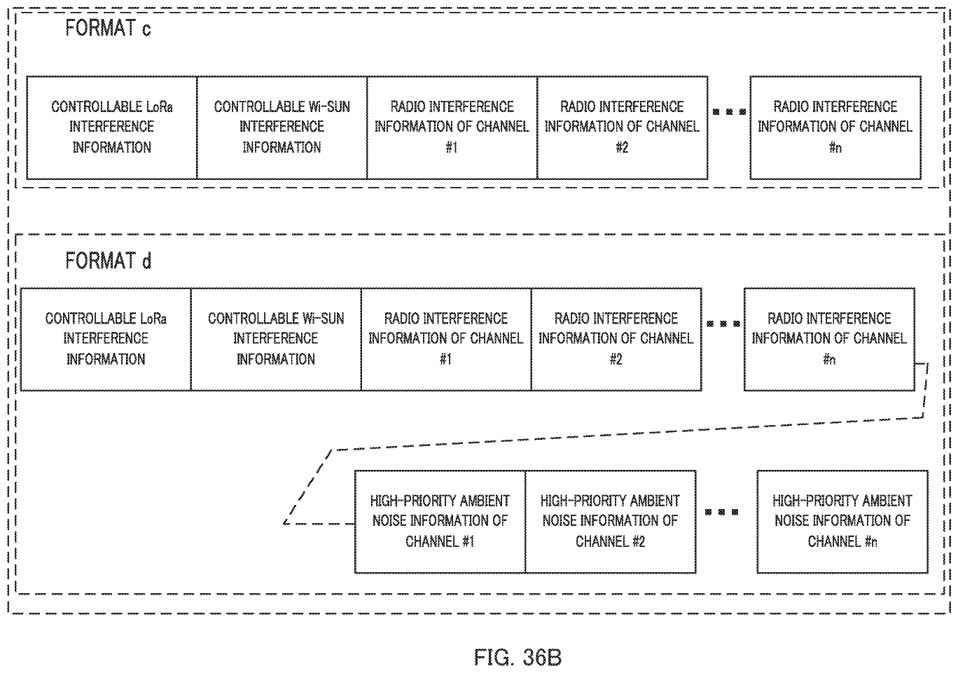

FIGS. 36A and 36B are views showing examples of the formats of notification information at four different notification timings. In the formats shown in FIGS. 36A and 36B, the description of fields similar to those of the format shown in FIG. 29 is omitted. For example, format d shown in FIG. 36B is similar to that of FIG. 29.

Format a of notification information of FIG. 36A is an example of the format of notification information at timing at which notification of controllable interference information is provided and timing at which notification of radio interference information and high-priority ambient noise information is not provided. Notification of radio interference information and high-priority ambient noise information is not provided in format a, so the “radio interference information” field and the “high-priority ambient noise information” field are omitted.

Format b of notification information of FIG. 36A is an example of the format of notification information at timing at which notification of radio interference information is provided and timing at which notification of controllable interference information and high-priority ambient noise information is not provided. Notification of controllable interference information and high-priority ambient noise information is not provided in format b, so the “controllable interference information” field and the “high-priority ambient noise information” field are omitted.

Format c of notification information of FIG. 36B is an example of the format of notification information at timing at which notification of controllable interference information and radio interference information is provided and timing at which notification of high-priority ambient noise information is not provided. Notification of high-priority ambient noise information is not provided in format c, so the “high-priority ambient noise information” field is omitted.

Format d of notification information of FIG. 36B is an example of the format of notification information at timing at which notification of controllable interference information, radio interference information, and high-priority ambient noise information is provided. Notification of controllable interference information, radio interference information, and high-priority ambient noise information is provided in format d, so no field is omitted.

For example, format a is selected at the notification timing of controllable interference information and at timing other than the notification timing of radio interference information and high-priority ambient noise information. Format b is selected at the notification timing of radio interference information and at timing other than the notification timing of controllable interference information and high-priority ambient noise information. Format c is selected at the notification timing of controllable interference information and radio interference information and at timing other than the notification timing of high-priority ambient noise information. Format d is selected at timing that is the notification timing of controllable interference information, radio interference information, and high-priority ambient noise information.

FIGS. 36A and 36B show examples of the formats of notification information at each notification timing where there are four different notification timings for the format of notification information, shown in FIG. 29. The present disclosure is not limited thereto.

<Example of Flow According to Variation 7>

An example of a process flow in base station 100 in the case where the notification frequency of controllable interference information and the notification frequency of uncontrollable interference information are set independently of each other will be described. A process flow in this case is similar to that of FIG. 27 described in Variation 4. In this case, the process of S1301 of FIG. 27 is different from that of Variation 4. Hereinafter, the process in S1301 of FIG. 27 will be described.

<Example of Flow of Process in S1301>

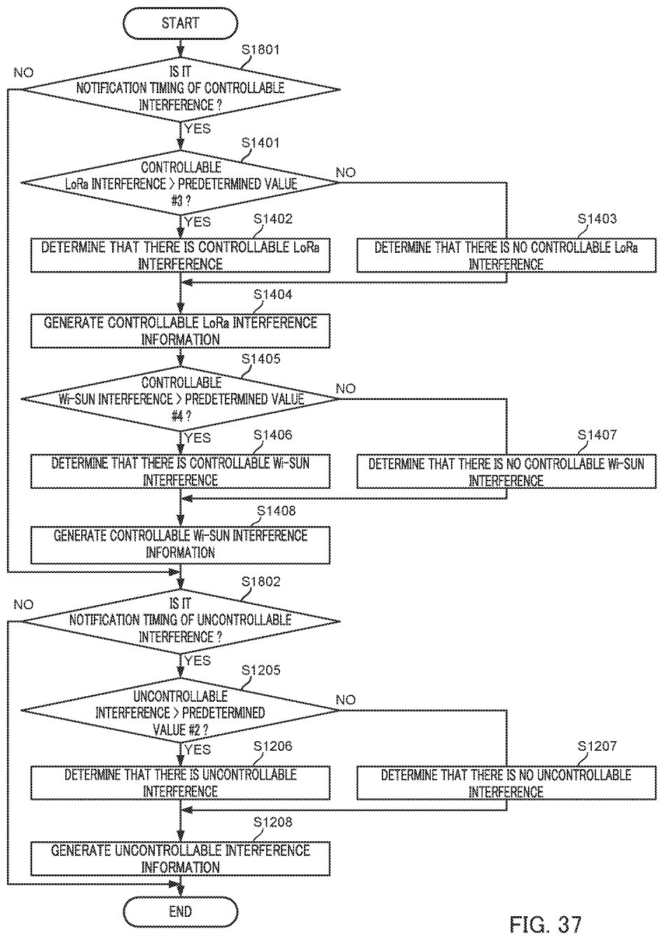

FIG. 37 is a flowchart showing a second example of a process to be executed in S1301 of FIG. 27. In FIG. 37, like step numbers are assigned to processes similar to those of FIGS. 24 and 28, and the description may be omitted.

In the flow of FIG. 37, S1801 is added before S1401 of the flow of FIG. 28, and the process of S1802 is added before S1205 of the flow of FIG. 28.

Base station 100 determines whether the notification timing of notification information is the notification timing of controllable interference information (S1801).

When the notification timing of notification information is the notification timing of controllable interference information (YES in S1801), the flow proceeds to the process of S1401.

When the notification timing of notification information is not the notification timing of controllable interference information (NO in S1801), the flow proceeds to the process of S1802.

Base station 100 determines whether the notification timing of notification information is the notification timing of uncontrollable interference information (S1802).

When the notification timing of notification information is the notification timing of uncontrollable interference information (YES in S1802), the flow proceeds to the process of S1205.

When the notification timing of notification information is not the notification timing of uncontrollable interference information (NO in S1802), the flow of FIG. 37 ends.

In the flow shown in FIG. 37, when the notification timing of controllable interference information and the notification timing of uncontrollable interference information are set independently of each other, generation of controllable interference information and generation of uncontrollable interference information are performed according to the respective timings. When the notification timing of notification information is not the notification timing of controllable interference information (NO in S1801), controllable interference information of each channel is not generated, so the processes of S1302 and S1303 of FIG. 27 do not need to be executed.

In Variation 4 described above, an example in which the notification frequency (for example, notification timing) of controllable interference information and the notification frequency (for example, notification timing) of uncontrollable interference information are set independently of each other has been described. With this notification, information with a lower notification frequency is not included in notification information, so the information content of notification information is reduced. With this notification, for example, channels are appropriately assigned to a terminal in a network, so it is possible to optimize the network (for example, both improvement in the efficiency of use of frequency and reduction of interference with another network and another system).

When the notification frequency of controllable interference information and the notification frequency of uncontrollable interference information are set independently of each other, the notification frequencies can be set according to the degree of fluctuations in controllable interference and the degree of fluctuations in uncontrollable interference when the degrees are different from each other. Therefore, it is possible to optimize the network (for example, both improvement in the efficiency of use of frequency and reduction of interference with another network and another system).

Here, a method of setting the notification frequency of controllable interference information and the notification frequency of uncontrollable interference information may be set to any method. The notification frequencies may be set to fixed values or may be variable. When the notification frequencies are variable, a method or the like in which base station 100 or the NW (for example, the control apparatus (see FIG. 1)) sets the notification frequencies and information indicating the notification frequencies are transmitted with a higher layer message or the like to a terminal is possible. To reduce redundant transmission information, the frequency of change in notification frequency is preferably smaller.

In the above-described embodiment and variations, classification of interference in the LPWA system and a notification method for information on the classified interference have been described. The present disclosure is not limited thereto. When, for example, interference monitoring is performed in a radio system, such as Wi-Fi, different from an LPWA system, the present disclosure may be applied. The present disclosure may be applied also to a case where an LPWA system and a radio system different from the LPWA system are mixedly present.

When a relay station is installed under a GW, the relay station communicates with each terminal and performs interference monitoring, the present disclosure may also be applied to notification information for providing notification from the relay station to the GW. In this case, each notification information format described in the above-described embodiment may be directly applied to notification information to be provided from the relay station to the GW. The above-described relay station can be installed dependently (for example, the case of configuration that relay station #1 transfers information received from relay station #2 to relay station #3 or a GW), and, in this case, notification of information including the result of interference monitoring may be needed to be provided from a relay station to another relay station. In this case as well, each notification information format described in the above-described embodiment may be directly applied. In this case, for example, the format of notification information relay station #1 receives from relay station #2 and the format of notification information in the case where relay station #1 transfers notification information received from relay station #2 to relay station #3 or the GW may be the same or may be different. In this case, a frequency at which notification information is provided between two relay stations and a frequency at which notification information is provided between a relay station and a GW may be the same or may be different. For example, a frequency at which notification information is provided from relay station #1 to the GW may be set so as to be smaller than a frequency at which notification information is provided from a relay station (for example, relay station #2) provided under relay station #1 to an upper-level relay station (for example, relay station #1).

In the above-described embodiment and variations, classification of interference in the LPWA system and a notification method for information on the classified interference have been described. The present disclosure is not limited thereto. When, for example, radio interference monitoring is performed in a radio system different from the LPWA system, the present disclosure may be applied.

In the above-described embodiment and variations, the LoRa mode and the Wi-SUN mode have been described as communication modes, for example. The present disclosure is not limited thereto. The LoRa mode may be replaced with any communication mode that performs spread spectrum, for example, CDMA (Code Division Multiple Access) communication mode. The Wi-SUN mode may be replaced with any communication mode that does not perform spread spectrum, for example, OFDM (Orthogonal Frequency Division Multiplexing) communication mode. The present disclosure may be applied also to the case where any communication mode in which spread spectrum is performed and any communication mode in which no spread spectrum is performed.

The terms “ . . . section” in the above embodiment may be replaced with other terms, such as “ . . . circuitry, “ . . . device”, “ . . . unit”, or “ . . . module”.

The terms “channel” in the above embodiment may be replaced with another term, such as “frequency”, “frequency channel”, “band”, “carrier”, “subcarrier”, or “(frequency) resources”.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

Some non-limiting examples of such a communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a radio base station backhaul line a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

Various embodiments have been described with reference to the drawings hereinabove. Obviously, the present disclosure is not limited to these examples.

Obviously, a person skilled in the art would arrive at variations and modification examples within a scope described in claims, and it is understood that these variations and modifications are within the technical scope of the present disclosure. Further, each component of the above-mentioned embodiments may be combined optionally without departing from the spirit of the disclosure.

Specific examples of the present disclosure have been described thus far, but these examples are only exemplary, and are not to limit the claims. Techniques recited in the claims include, for example, variations and/or modifications of the specific examples exemplified above.

The disclosures of Japanese Patent Application No. 2019-061454, filed on Mar. 27, 2019 and Japanese Patent Application No. 2019-121145, filed on Jun. 28, 2019, each including the specification, drawings, and abstract, are incorporated herein by reference in their entirety.

### INDUSTRIAL APPLICABILITY

One embodiment of the present disclosure is suitable for radio communication systems.

### REFERENCE SIGNS LIST

100 Base station
101 Receiver
102 Demodulator/decoder
103 Interference classification processor
104 Controllable interference processor
105 Radio interference processor
106 Ambient noise processor
107 Notification information generator
108 Notification information controller
109 Communication controller
110 Control signal generator
111 Encoder/modulator
112 Transmitter

1. A base station that supports a first radio system and that belongs to a first network, the base station comprising:
an interference classification processor that classifies interference including first interference from a radio apparatus that supports the first radio system and that belongs to the first network, and second interference from a radio apparatus that supports the first radio system and that belongs to a second network different from the first network; and
a controller that outputs notification information including information on the first interference and information on interference including the second interference to a control apparatus of the first network.

2. The base station according to claim 1, wherein
the interference classification processor classifies the interference including the second interference into the second interference and third interference from a radio apparatus that supports a second radio system different from the first radio system, and
the information on the interference including the second interference includes information on the second interference and information on the third interference.

3. The base station according to claim 2, wherein
the information on the first interference indicates a comparison result of an interference amount of the first interference with a first threshold,
the information on the second interference indicates a comparison result of an interference amount of the second interference with a second threshold,
the information on the third interference indicates a comparison result of an interference amount of the third interference with a third threshold, and
the number of the third thresholds is greater than the number of the first thresholds or the number of the second thresholds.

4. The base station according to claim 2, wherein
the controller determines any one of a plurality of levels by comparing an interference amount of the third interference with a plurality of third thresholds and sets the determined level for the information on the third interference.

5. The base station according to claim 4, wherein
when the interference amount of the third interference is less than or equal to a fourth threshold included in the plurality of third thresholds, the controller generates the information on the third interference, not including a comparison result with any threshold greater than the fourth threshold and included in the plurality of third thresholds.

6. The base station according to claim 4, wherein
the plurality of third thresholds is set based on one or more communication modes in the first radio system and/or a difference in transmission power in the one or more communication modes.

7. The base station according to claim 2, wherein
the controller determines a priority of the second radio system over the first radio system and adds priority information indicating the determined priority to the notification information.

8. The base station according to claim 7, wherein
when the controller determines that the second radio system is higher in priority than the first radio system, the controller reduces an information content of the information on the third interference in the notification information.

9. The base station according to claim 2, wherein
the controller sets a notification frequency of the information on the third interference to a frequency different from a notification frequency of the information on the first interference and/or the information on the second interference.

10. The base station according to claim 9, wherein
the controller decreases a notification frequency of the information on the third interference in a steady state where an interference amount of the third interference exceeds a predetermined amount continuously over a predetermined time with respect to a notification frequency of the information on the third interference in a state other than the steady state.

11. The base station according to claim 9, wherein
the controller adds notification presence/absence information indicating whether the information on the third interference is included in the notification information to the notification information.

12. A base station that supports a first radio system and that belongs to a first network, the base station comprising:
an interference classification processor that classifies interference detected in each of a plurality of channels into first interference from a first radio apparatus that supports the first radio system and that belongs to the first network and second interference different from the first interference; and
a controller that outputs notification information including at least one of information on the first interference and information on the second interference to a control apparatus of the first network, wherein
the information on the first interference indicates a statistical amount of the first interference in two or more channels.

13. The base station according to claim 12, wherein
the statistical amount is at least one of a mean, a maximum, a minimum, and a median of an interference amount of the first interference in each of the two or more channels.

14. The base station according to claim 12, wherein
the information on the first interference indicates a statistical amount of the first interference in all of the plurality of channels.

15. The base station according to claim 12, wherein
the controller outputs first notification information including the information on the first interference and second notification information including the information on the second interference at frequencies different from each other.

16. The base station according to claim 12, wherein
in the notification information, information on the first interference due to communication in a first communication mode and information on the first interference due to communication in a second communication mode are distinguished from each other.

17. The base station according to claim 16, wherein
in the notification information, information on the first interference in a channel to be assigned to a first terminal that uses the first communication mode, information on the first interference in a channel to be assigned to a second terminal that uses the second communication mode, and information on the first interference in a channel allowed to be assigned to any of the first terminal and the second terminal are distinguished from one another.

18. The base station according to claim 16, wherein
the first communication mode is a communication mode that uses a spread spectrum mode, and
the second communication mode is a communication mode that does not use a spread spectrum mode.

19. The base station according to claim 12, wherein
the interference classification processor classifies the second interference into third interference from a radio apparatus that supports the first radio system and that belongs to a second network different from the first network and fourth interference from a radio apparatus that supports a second radio system different from the first radio system,
the interference classification processor determines a priority of the second radio system over the first radio system, and
the information on the second interference includes information on the third interference and includes information on the fourth interference in a state where the second radio system is higher in priority than the first radio system.

20. The base station according to claim 19, wherein
the information on the second interference indicates a statistical amount of an interference amount of the third interference and an interference amount of the fourth interference in a state where the second radio system is higher in priority than the first radio system.

21. A notification method comprising:
classifying interference including first interference from a radio apparatus that supports a first radio system and that belongs to a first network and second interference from a radio apparatus that supports the first radio system and that belongs to a second network different from the first network; and
generating notification information including information on the first interference and information on including the second interference.
